(19) United States
(12) Patent Application Publication
(10) Pub. No.: US 2018/0357675 A1
(43) Pub. Date: Dec. 13, 2018

(54) Mobile Device Operating System for Providing Enhanced Communications Via Segmented Message Templates

(71) Applicant: BrandintelX, Inc., Silver Spring, MD (US)

(72) Inventors: Sterling A. Ward, Washington, DC (US); James Bud Ward, Washington, DC (US); Charles E. Casteel, SR., Pooler, GA (US)

(73) Assignee: BrandintelX, Inc., Silver Spring, MD (US)

(21) Appl. No.: 15/973,478

(22) Filed: May 7, 2018

Related U.S. Application Data
(62) Division of application No. 13/800,832, filed on Mar. 13, 2013, now abandoned.
(60) Provisional application No. 61/649,718, filed on May 21, 2012.

(51) Int. Cl. G06Q 30/02

(52) U.S. Cl. CPC G06Q 30/0267; G06Q 30/0264

(57) ABSTRACT

Provided is a display control mechanism for improving functionality of a handheld mobile device including an operating system (OS). The display control mechanism includes a content delivery system (CDS) configured to create an advertising (ad) message, the add message being represented by templates formatted into a plurality of portions. A first template portion includes instructions directing how to render the ad message to interact with the mobile device based upon capabilities of the device, a second template portion includes instructions directing what to render as content of the ad message based upon the device capabilities, and a third template portion includes data for use in rendering the ad message. A content message layer manipulates the OS and the device capabilities, and includes one or more application programming interfaces (APIs) configured to receive, store, and render messages sent by CDS.

### CROSS REFERENCE TO RELATED APPLICATIONS

This application is a Divisional of U.S. application Ser. No. 13/800,832, filed Mar. 13, 2013, now pending, which claims the benefit of U.S. Provisional Application No. 61/649,718, filed May 21, 2012, now expired, all of which are incorporated by reference in its entirety. This application is related to U.S. application Ser. No. 13/800,638, and filed Mar. 13, 2013, and U.S. application Ser. No. 13/801,246 filed Mar. 13, 2013, and U.S. application Ser. No. 13/801,343 filed Mar. 13, 2013.

### TECHNICAL FIELD

The present disclosure relates to a mobile device operating system software for providing an enhanced messaging communications capability. More particularly, the present disclosure relates to a mobile device operating system configured to use messaging template segments tailored to capabilities of a particular mobile device.

### BACKGROUND

Mobile device operating system software controls communications to and from the mobile device. One type of communications delivered to mobile devices include display impression advertisements. Display impression advertisements (ads) on mobile devices are primarily recycled internet ads, simply down sized to fit the smaller screen of mobile devices. Some impression ads are provided through mobile internet websites and others are provided through thin-clients embedded into mobile content products (applications). Both methods of providing the impression ads are widely distributed through ad networks. There are a fast growing number of content providers enabling these thin-clients to serve pictures, banners, or small video clips into the pre- or post-loading screens of mobile games, videos, music tracks, and upper, middle, and lower sections of mobile application displays. By recycling these internet-based ads, coupled with the ad network's ubiquitous reach, it makes this advertising distribution channel a very inexpensive and technically efficient method to send ads to large audiences.

There are at least three drawbacks or limitations to today's mobile display impression ads:
1) Annoyance Factor—impression ads are displayed while users are actively using their mobile device, and the line between valuable advertising content and spam is never going to move in favor of the advertiser. The frequency and ubiquity of such ads can quickly reach a point of diminishing return for the advertiser and/or publisher if poorly executed;
2) Underutilized Technology—because impression ads are displayed while the device is in use, the industry's best practices, as outlined by the Mobile Marketing Association (MMA), discourage the use of most of the native capabilities of the device (such as the speakers, LED flash, vibrator, and the like), all to minimize the annoyance factor as witnessed by internet advertising; and
3) Undeveloped Measurement—impressions served, click-thru rates, page views, duration, and conversion are today's standard for ascertaining effectiveness of mobile device impression ads; while each of these are measurable from a technology perspective, they provide very limited actionable insight to the advertisers that inform their decision on how to maintain or strengthen their market position.

In the current mobile advertising environment, there are more mobile devices than there are TVs and internet-connected PCs. Moreover, mobile devices (especially mobile phones) are typically with an individual, especially at the point of purchase. Therefore, the potential to reach large audiences and influence their purchasing decisions when the mobile device is close to a retail outlet is commanding broad enthusiasm.

Based on lessons learned from the Dot-Com era of internet advertising and coupled with the fact that in conventional ad delivery methods, mobile display advertising is delivered while the device is in active use, the MMA has developed best practices to guard against crossing the line in the consumer's perception of what is valuable ad content and what would be considered spam or junk. The intent is to avoid the internet-like annoyance factor from happening in mobile. Furthermore, additional heightened concern centers on the personal and private nature of mobile devices and the inherent sense of privacy expected from individuals while using their devices.

Using internet advertising as a framework, along with the goal of not annoying the consumer, the MMA's best practices have established standards for: opt-in to an ad; opt-out of an ad; ad size and format; when and where ads are displayed; and guidelines for how ads are displayed. The net result of the MMA's best practices has been an evolution to a wholesale reuse of the internet business model, scaled down to fit the smaller screen size of mobile; thus, adopting a low-profile approach to display impression ads so as not to draw too much attention away from the user's intended use of the device: to make and receive calls, read books, view videos, listen to music, play games, browse the internet, and the like.

In a world of 3,000 ad messages a day and technology and behavior that facilitates unprecedented ad skipping, the “impression” ad is less and less able to sway purchase habits. The measuring of eyeball impressions is no longer good enough for many forms of marketing. The shifting from commodity-oriented benchmarks of input measures such as cost per thousand impressions (CPMs) (or cost per 1,000 viewers) to more output-oriented measures such as cost per hand-raiser and cost per lead represents the next evolutionary step in measuring and predicting the effectiveness of advertising campaigns.

In the world of advertising that includes TV, radio, print, online, and mobile, the distribution model for those 3,000 ad messages that are created every day is often one-to-many, where the advertiser sends one ad to many individuals (also known as the shotgun approach). Consumers are merely on the receiving end of those ad messages with little opportunity to have a direct conversation or relationship with advertisers about the advertisements they individually received. Focus groups, sample surveys, completed questionnaires, and the like are used to provide linkage between the advertiser and the consumer, namely, to provide consumer segmentation data to categorize people for targeting purposes and to provide feedback on already executed ad campaigns.

Advertising is a mature, yet evolving business model, but the newer measures for ad effectiveness—hand-raisers, leads, and increase in sales—are rarely connected from the ad to the individual consumer and back to the advertiser, and none are done on a large scale.

Tremendous amounts of capital and intellectual resources are expended in delivering and measuring advertising to mobile devices today by companies worldwide of all sizes seeking to capture the next great entrepreneurial event. Each is competing in an environment that was not designed to deliver or measure advertising messages.

The current wireless infrastructure has three principle participants (wireless carriers, device manufacturers, and software operating system developers). Each tends to innovate in a different direction, and neither participant has a vested interest in making advertising on mobile devices work effectively. Thus, the current state of the wireless infrastructure is synonymous to creating a square peg and trying to fit it into a round hole created by advertisers' need to deliver and measure mass advertising to targeted audiences.

In the conventional wireless infrastructure, the challenges that limit advertising's potential are caused by the fact that there are numerous handsets manufactured with non-standard operating systems (OS) that are each connected on different wireless carriers' networks. Collectively, these three different components fracture and constrain the scalability of a mass advertising delivery system. There are too many different devices with too many different OSs to deploy an effective ad delivery system that reaches large audiences. Therefore, to thrive in this fractured environment, advertisers have identified and latched onto low common denominator ad delivery methods (for example, text messages, tiny banner ads, and mobile search results) to reach their targeted audiences. Unfortunately, these ad delivery methods tended to create separate stovepiped customer acquisition requirements that further inhibit scalability and as a result create even more fragmentation.

Additional challenges to reaching mobile advertising's long-term potential are the lack of standards and verifiable methods for reliably measuring whether an advertising message was displayed to the intended audience on the mobile device and for ascertaining the mobile device user's responses to and engagement with the displayed advertisement.

There are many methods currently deployed for displaying and measuring advertising to mobile devices. For instance, it is known to display an advertising message on a lock screen display of a mobile device. What is missing is a unifying element that can bridge devices, OS's, and wireless carriers and that enables a single scalable solution. As a result, compared to TV, radio, print, and online, mobile advertising continues to be constrained as a distribution channel in the global world of direct advertising.

### SUMMARY

Given the aforementioned deficiencies, embodiments of the present invention provide a display control mechanism for improving functionality of a handheld mobile device including an operating system (OS), the display control mechanism including a content delivery system (CDS) configured to create an advertising (ad) message, the ad message being represented by templates formatted into a plurality of portions. A first template portion includes instructions directing how to render the ad message to interact with mobile device based upon capabilities of the device, a second template portion includes instructions directing what to render as content of the ad message based upon the device capabilities, and a third template portion includes data for use in rendering the ad message. A content message layer manipulates the OS and the device capabilities, and includes one or more application programming interfaces (APIs) configured to receive, store, and render messages sent by CDS.

To explain further, by one aspect, an ad is never rendered to a user while the user is actively using the mobile device. In this case, ads are only rendered on the lock screen display during the period between wake up of the mobile device and unlocking of the device. In another aspect, ads are rendered only when the user initiates use of the device and not when the user responds to the device (in other words ads are not rendered upon notification of an incoming call, text, or message alert). Many devices display a picture from the user's address book or a wallpaper image during an incoming call, and this practice could continue. Although no ads are rendered while actively using the mobile device, whether on a call, using the Internet, texting someone, or any other user activity, the mobile device user can still opt-in to any prior art, ad supported campaign or program that is not in accordance with these disclosures.

Consequently, in various aspects, the disclosed edge technology enables the creation of a consistent, predictable, and user controllable line between advertising content and annoyance upon which both users and advertisers can rely.

The MMA's best practices are satisfied by uniquely addressing the ad annoyance factor. In keeping with this element, the subject matter of this disclosure can fully leverage virtually every technology present on mobile devices—today and in the future—to create a new class of eye-catching and engaging impression ads. This is achieved by manufacturing, integrating, bundling, configuring, modifying, installing, or otherwise designing the edge technology directly onto selected mobile devices and creating a distinct time, place and user discretionary control of the impression ad.

So configured, the disclosed subject matter creates a new technology driven impression ad that does not exist today. One implementation includes a Content Message Layer (CML) manufactured, integrated, bundled, configured, modified, installed, or otherwise designed into the operating system of the mobile device (such as a fat client). This approach is considered to be edge technology because it sits at the farthest edge of the wireless carrier's network, inside the mobile device, and in the end-user's hand. The CML effects one or more of the following attributes:
a) Enables the non-intrusive ad rendering;
b) Enables the impression ad to instantly start without server or communication related delays;
c) Enables full use of hardware, software, and operating system elements native to the mobile device to create uniquely mobile impression ads;
d) Contains a physics engine to create additional uniquely mobile impression ads;
e) Enables the user to select how he/she wants to respond and/or to share an ad;
f) Accurately captures and measures ad delivery, rendering and user's direct and indirect ad responses;
g) Leverages time and location based ad delivery and rendering;
h) Addressable and linked to a content server to establish anonymity and two-way communication;
i) Facilitates transparency functionality and substantial privacy and security safeguards;
j) Contains a set of application programming interfaces (APIs) for third-party innovation and independent audience measurement; and
k) Facilitates a new robust alert messaging system for foreign or domestic national, state, county, and local government entities (and their foreign equivalents), and wireless carriers.

The edge technology by one approach facilitates a new framework for creating lock screen display impression ads by unleashing the innovative forces of third-party software developers to create new, exciting, and eye-catching ads. Using a software developer's kit (SDK), developers and advertisers are only limited by their imaginations to create new impression ads uniquely for rendering on a mobile device. The SDK is an ad creation toolkit that enables the developer to leverage the edge technology on the mobile device. A broader array of design elements for impression ad creation is possible because access can be provided to a physics engine and to all the native capabilities of the device (for example, microphone, accelerometer, gyroscope, compass, vibrator, GPS, LED flash, proximity sensor, Near Field Communication (NFC), and the like). These native device capabilities are used in both impression ad rendering (the first thing you see or experience), as well as the user interaction (how the user engages and plays/interacts with the ad).

The following three examples illustrate the distinctiveness of the new impression ads using the noted edge technology—both how they are rendered and how the user interacts with them.

Example Ad 1

The instant the wake button is depressed on a mobile device—Animated mercury balls quickly roll and collide with each other onto the screen from all directions; simultaneously, the device correspondingly vibrates and makes a rumbling sound; with each collision a sucking sound is heard as the balls congeal together; eventually (for instance, three seconds later) the congealed mercury forms an accurate representation of a particular brand of pick-up truck, and then to a quiet background a gruff voice says “this is one tough truck.” The user could then:
1) shake the device in response to which the mercury balls will scatter off the screen, then the sequence would start all over again;
2) further delay the unlocking process, and after five seconds the screen would go black and the sequence would start over again, but with every iteration the action would slow down by 25%, and after the fifth iteration it would freeze with the pick-up truck staying on the screen;
3) long-touch the screen if the user was interested in learning more about the pick-up truck (with such a long-touch, the screen would react as if a finger was inserted into water and ripples would start from the user's touch point and ripple out to the screen's edges, and when the user lifts the finger from the long-touch, the water and pick-up truck would explode off the screen accompanied by a corresponding sound and vibration, and then the screen would go black); or
4) at anytime—beginning, middle or end—of the ad rendering process, the user without delay, can unlock the mobile device.

Example Ad 2

The instant the wake button is depressed—A liter diet cola bottle, full, sits in the middle of the screen with its top on; after one second a popping sound is heard, the bottle top flies off the bottle and the screen, and the foam from the soda first begins to shoot up out of the bottle and then it falls back down onto the ground, all while the bottle rotates clockwise; concurrently, the mobile device's vibrator mimics a rumbling feeling while the speakers emit a fizzing, spraying sound; and while the spraying continues, uninterrupted, a text message scrolls on the bottom of the screen saying ‘Touch Now for 10% Off’. The execution of this ad is predicated on the user being within a geo-fence designation of a participating grocery store; if the user is not, a different ad would render. Thereafter:
1) the user could shake the mobile device up and down, and the fluid inside the bottle would correspondingly jostle up and down; this would also cause the spraying from the bottle to accelerate higher and higher; and concurrent to it all, the rumbling feeling and fizzing sound would equally correspond to the shaking of the bottle;
2) the user could touch the bottle to stop its clockwise rotation; or flick gesture, left or right, to make the bottle spin faster in a clockwise or counter clockwise rotation;
3) the user could lean the mobile device to the left or right; this would alter the direction of the spraying animation, and the spraying liquid would first tilt in the direction of the leaning and then to the ground in accordance with the laws of physics;
4) if the user was interested in learning more about the diet cola offer, the user could long-touch the screen; the spraying animation would all reverse back into the bottle, the bottle cap would re-fasten to the bottle top, and then large lettered font would appear in the center of the screen saying ‘Thank You’; or
5) at anytime—beginning, middle or end of the ad rendering process, the user, without delay, can unlock the mobile device.

Example Ad 3

The instant the wake button is depressed—A woman appears on the screen, dressed in a fashionable business suit from a local department store. The woman stands with one hand on her hip and the other extended outwardly with her palm up. The department store's logo is in the bottom left corner and after the first two seconds the image of the woman slowly rotates clockwise, while at the same time, little square pieces of paper fall from the top of the screen with different lettering written on them—some say 5% off, some 10% off, and others say 15% off. The little squares fall over the woman and eventually to the ground, but one lands on the woman's outwardly extended hand—it reads 10% off. All of this takes five seconds. As with the prior two examples, user interaction can occur by:
1) blowing air into the mobile device's microphone and causing all of the pieces of paper on the ground and in the woman's hand to blow upwardly to the top of the screen. If the user continues to blow, all the papers will also continue to blow upwardly and swirl at the top of the screen. When the user stops blowing, the paper will re-float back down again, and based on randomness, the same or a different discount percent amount could land in the woman's hand. This could be repeated until the 15% off paper lands in the woman's hand;
2) the user long-touching the 15% off square paper in the woman's hand if the user is interested in learning more about the department store's discount offer. The department store's logo on the bottom left of the screen would move and take over the entire screen, and then the whole screen would fade to white; or
3) at anytime—beginning, middle or end—of the ad rendering and user interaction process, the user without delay, can unlock the mobile device.

The three examples demonstrate the innovation and ad engagement possibilities from the disclosed edge technology. Generally speaking, impression ads with instant start, use of native device capabilities to interact with the ad, rendered objects responding to the laws of physics, and dynamic interaction with the ad were not previously possible with conventional display impression ads on the lock screen display. The disclosed subject matter enables these possibilities because of the time and place where the impression ads are rendered. By anyone's standards, mercury balls rolling on the screen to advertise a pickup truck while reading your email, playing a game, or browsing the internet would definitely be annoying. But such an ad that you know will render on the lock screen display, and, if you so desire, can interact with and control the amount of time that the ad is rendered, makes such advertising manageable.

Moreover, the disclosed subject matter can create new actionable insights for the advertiser that better inform its decision on how to maintain or strengthen its market position that does not exist today. For instance, the disclosed edge technology effects an ad effectiveness measurement. Once the user acknowledges the rendered ad to learn more about the product, service, or offer, an additional feature of the edge technology broadens and standardizes the user's responses to a given ad, essentially providing the user with consistent and predictable ad response choices. In contrast, today's ad responses are pre-selected by the advertiser, a single call-to-action, and the majority of advertisers choose for the user to launch a web browser. While the web browser provides the advertiser a wide selection of potential ad responses for the user; due to technology limitations, business rules, and/or enabling user simplicity, the advertiser usually provides only a single ad response. In addition to launching a web browser, other conventional pre-selected ad responses include: click to call, email, text, or to launch a mobile application. Furthermore, from a user's perspective, every advertiser's website is slightly different. There is no consistency of what and where the product or service information is presented, and there is no standard way across the different advertiser's other digital assets to know how to navigate to learn more about the product or service to help the user get to a buying decision.

In one such approach, the advertiser is provided with a standard framework for organizing and presenting their website information and other digital assets about their product or service. This framework also provides the user with multiple and consistent ad response choices to learn more about a product, service, or offer. Furthermore, this framework provides the user with predictable navigation paths, across all advertisers and all product and service categories, for the user to know how to find out more about the advertisements on his or her mobile device. This framework is referred to as Learn More Attributes, which encompasses actionable insight in one or more of the four phases of the following sales purchase funnel, plus a social component.
Awareness:
   Print Media
   Video Media
   Audio Media
   Website
Interest:
   Map/Location
   Product Reviews
   Price Comparison
   Survey/Polling
   Call
   eMail/Text
   Product Search
Desire:
   Shopping List
   Wish/Gift List
   Shopping Cart for Purchase
Action:
   Mobile Ahead Reservation/Purchase
   Redeem Coupon
   Buy—In Store/Online
   Purchase History
Other:
   Social

From reading press releases and product reviews to adding an item to a shopping cart or sharing an ad with a friend, the Learn More Attributes framework provides consistent choice, immediacy, and transparency to the user's experience. By empowering users to easily navigate and engage in multiple ways with the advertiser—in the time and manner of their choice—it fits within a common-sense belief that when people get more personally involved in the marketing behind the advertisement, they are likely to develop a more favorable impression of an advertiser's brand. Thus, learning something important about the advertised product or service often facilitates the user getting to a buying decision.

In another aspect, based on which Learn More Attribute the consumer engages, the framework is also able to quantify each attribute and assign it a numeric value. For example, if the user's engagement is in the higher end of the purchase funnel (such as awareness and interest), a lower value is given; whereas, if the user's engagement is in the lower end (such as desire and action), a higher value is given. Accordingly, based on each Learn More Attribute the consumer engages for any ad, the disclosed technology is able to determine an ad effectiveness measurement based on a numeric value.

So configured, the disclosed ad delivery channel is a disruptive change to the evolving world of advertising that offers an authentic one-to-one relationship between the advertiser and the individual consumer—on a mass scale. In contrast to the prevailing one-to-many model, the disclosed subject matter provides a scalable one-to-one model where advertisers use a rifle, and not a shotgun, to reach their targeted audiences.

By connecting the disclosed innovative impression ad directly to the consumer and advertiser, this enables closed-loop ad campaigns that can be repetitious, episodic, progressive, or build to a crescendo or an event. All are highly effective communication tactics for product or services branding initiatives at every phase of the sales purchase funnel.

The consumers are the most important element in the advertising delivery channel. Their acceptance and active participation is the life blood of the delivery channel. To partially gain and nurture their willingness to participate in the advertising delivery channel, strong privacy and security safeguards have been developed to provide them with transparency and control of their data and an assurance of anonymity.

An understanding of how advertisers have the ability to have closed-loop, progressive conversations with individual consumers begins with understanding how the consumer engages the Learn More Attributes, and how that engagement is tied directly to a known profile (such as the anonymous user's).

By one example, the consumer completes a two-part profile (for instance, a consumer oriented profile as well as a trade or professional oriented profile). The former profile is geared towards business to consumer (B2C) advertising, and the latter profile is geared towards business to business (B2B). Next, an overlay of the consumer's explicit response/no response to every ad received as well as other related implicit advertising activity is provided.

In one aspect, at any time and frequency, the consumer can see what information/data is tracked about him or her, and the consumer can subsequently delete, modify, or elevate any tracked item. Thus, users are provided transparency and user control of their data.

Using the consumer's self-identified profile, combined with the explicit and implicit tracking data, consumer segmentation information will serve as a rollup of liked-profiled individuals (i.e., real people), one-by-one, into a database. Unlike the prevailing practice of using focus groups or sample surveys to define publishers and distribution channels, consumer segmentations in accordance with this approach involve real people. The ability to access profiles of real people for targeted advertisement, at scale, instead of sample profiles and focus group data, will have an enormous impact on, and will lead to profound change to, all advertising, and not just mobile.

Display advertising via TV, radio, print, online, or mobile does not have scalable models for having a closed-loop progressive conversation between an advertiser and the consumer. The sector that best performs such a closed-loop progressive conversation is direct selling. The very nature of direct sells affords the opportunity to prospect, discuss features and benefits to overcome the prospect's objections, and come to a sale/closure. Direct selling is regarded as the most effective selling tool, but it is also the most expensive.

By sending an ad directly to the consumer and then sending the consumer's response/no response directly back to the advertiser, in a closed-loop conversation, the disclosed subject matter will be able to achieve many of the attributes of direct selling, but at a much lower cost.

In one example, when an advertiser selects from the database of self-identified consumers, the advertiser initiates the closed-looped conversation. The next steps include: the advertiser creates a new impression ad with the SDK; the advertiser populates the Learn More Attributes ad responses; the advertiser selects a time and/or geographical location for ad delivery; and the advertiser completes the impression ad acquisition process. Then, based on a match between the user's profile information and the advertiser's target audience, the intended ad message is delivered to addressable individuals.

The power of the noted closed-loop progressive conversation can be seen in the following example of an outdoor camping advertiser executing an ad campaign for an end-of-summer clearance sale.

To start, assume there are one million users nationwide with mobile devices operating in accordance with various aspects of the disclosed subject matter. The outdoor camping advertiser first selects, for example, the geographical area of metropolitan Washington D.C., and the Message Manager reveals there are 10,000 users in the area. Next, the advertiser selects “enjoys outdoor activities” consumer segmentation, and the Message Manager reveals 1,000 self-identified outdoor users. For privacy concerns, the user's name, mobile number, address, or any other identifiable attributes are never disclosed to the advertiser unless authorized by the user; however, the advertiser does know definitively that there are 1,000 real people in the Washington area who like outdoor activities (which comprises the advertiser's target audience for the end-of-summer clearance sale).

For sake of simplicity, it is assumed that all 1,000 users received the end-of-summer advertisement. Out of those 1,000, only 100 users engaged in selected Learn More Attributes and converted the ad to a digital coupon, and then, ultimately bought a tent. Through a process on the device, this example is able to track those purchases. A second group of 200 users received the ad and engaged in selected Learn More Attributes, but did not buy anything. And finally, the third group of 700 users unlocked the device without any delay, and was merely exposed to the ad.

With three weeks left to the end of the sale, the advertiser decides to send out a second ad. With the ability to have a progressive conversation, the advertiser does not send the same ad to the same 1,000 users. Instead, the advertiser crafts three separate follow up ads, each relevant and cognizant of the user's place in the purchase funnel. To the first group that purchased a tent, a follow-up ad is sent thanking them and incenting them to buy tent accessories. To the second group that engaged the ad but did not buy anything, a follow-up ad is sent that includes more information about features and benefits. And to the last group that ignored the ad, a follow-up ad is sent that is a little more innovative and eye-catching in hopes of getting their attention.

This progressive conversation, mindful of the user's previous response, could continue, with several iterations, until the conclusion of the tent sale.

The disclosed closed-looped conversation, similar to direct selling, provides advertisers with actionable insights to inform them about what to say and/or do next in their ad campaign in reply to the user's previous response/no response.

Another compelling aspect of the closed-looped progressive conversation is the unparalleled measurement information captured. The database collects data into three primary buckets (advertisement, advertiser, and consumer). Each ad and response contains unique identifiers that correspond to this database structure. All explicit data collected from the consumer's engagement with the ad and implicit data collected from other advertiser related interaction are similarly identified. This data is compiled and organized to create numerous views for analysis; and three such views are the Ad Centric View, Advertiser Centric View, and Consumer Centric View.

In the Ad Centric View, essentially every ad sent to every consumer by every advertiser creates the first view. Using the ad effectiveness measurement ascertained from the Learn More Attributes, the effectiveness of every ad can be ranked in the database. This data can then be parsed by: industry; sector; geography; product group; individual product; advertiser; online; brick and mortar; consumer segment; and more. Thus, this view creates a quantitative way to rank overall ad effectiveness across all advertisements in the database.

In the Advertiser Centric View, essentially every ad sent to every consumer by each advertiser creates the second view. Using the same ad effectiveness, every ad sent by each advertiser to every consumer segment can be ranked. Likewise, the disclosed approach then can parse the data by: industry; sector; geography; product group; individual product; online; brick and mortar; consumer segment; and more. This view makes it easier for the advertiser to determine which ad campaigns were effective and which were not. Additionally, a meaningful overall brand ranking of all the advertisers is readily available.

In the Consumer Centric View, essentially every ad sent by every advertiser to each consumer segment creates the third view. Using the same ad effectiveness, every ad sent by every advertiser to each consumer segment can be similarly ranked. Likewise, the disclosed subject matter is then able to parse the data by: industry; sector; geography; product group; individual product; online; brick and mortar; and more. This view makes it easier to determine the ads to which the consumers best respond, what products and services they are most interested in, and which advertisers they may view favorably.

In various approaches, the disclosed subject matter creates new actionable insights for the advertiser that better inform decisions on how to maintain or strengthen their market position that does not exist today. These three views possible with various implementations of the disclosed technology provide credible ways to evaluate the return on the advertiser's dollar spent. Using this intelligence illuminates the consumers' unique interests and needs and allows the advertisers to ascertain actionable insight to discover what matters and what is relevant to the consumers. Such options were generally not possible using impressions served, click-thru rates, page views, duration, and conversion—all today's standard for ascertaining effectiveness of mobile device impression ads. So configured, the disclosed technology provides advertisers unprecedented tools for both finding prospects to fill their purchase funnel and for moving them down the funnel to become long-term loyal customers. Ultimately, when compared to other ad delivery channels, the disclosed technology gives advertisers more marketing control over how to spend their advertising dollars.

### BRIEF DESCRIPTION OF THE DRAWINGS

FIG. 1 is a block diagram of five elements of an example Message Delivery Ecosystem;

FIG. 2 is a block diagram illustrating the major sub-components of an example Content Delivery System and the connection of those sub-components to the remainder of the Message Delivery Ecosystem of FIG. 1;

FIG. 3 is a block diagram illustrating an example protocol for the Communication Service Provider and an example interconnection of the Communication Service Provider to other elements in the Message Delivery Ecosystem of FIG. 1; and

FIG. 4 is a block diagram illustrating details of an example Content Message Layer in the Mobile Device element and the interconnection of the Content Message Layer to other elements in the Message Delivery Ecosystem of FIG. 1.

Those skilled in the art will recognize and understand that the illustrated systems may be comprised of a plurality of physically distinct elements as is suggested by the illustrations. It is also possible, however, to view these illustrations as comprising a logical view, in which case one or more of these elements can be enabled and realized via a shared platform. It will also be understood that such a shared platform may comprise a wholly or at least partially programmable platform as are known in the art.

### GLOSSARY OF TERMS AND DEFINITIONS

For the purpose of clarity, the terms set forth hereinafter are specifically defined for use herein:

The term “Message Delivery Ecosystem” or “MDE” refers to the methods and apparatus(es) that deliver addressable advertisement and alert messages to a mobile device using a communication protocol produced by a message creator. The mobile device receives the addressed advertisement and alert messages in background, stores them, and then, based on defined triggering events, instantly renders the message content deploying/using device capabilities native to the mobile device. Modern mobile devices contain a locking mechanism to prevent accidental use. These advertisement and alert messages are rendered while the mobile device is in the locked state and are not rendered after the mobile device is unlocked. While in the locked state, the mobile device enables the addressed mobile device user to interact with the message using the device capabilities native to the mobile device. Using a communication protocol, the mobile device sends delivery, rendering confirmation, and other measurable information back to the initiator of the message for analysis to ascertain message effectiveness and determination of potential next action.

The term “mobile device” refers to any device deploying any operating system that has been manufactured, installed, modified, bundled, integrated, configured, or otherwise designed with the Content Message Layer and communicating on any voice and/or data network.

The term “mobile device user” or “anonymous mobile device user” or “user” refers to the registered owner of the mobile device, and can also be referred to as the consumer or targeted consumer segment.

The term “mobile device capabilities” refers to the mobile device's hardware, firmware, software, and operating system native components for rendering and interaction purposes.

The term “advertiser” or “government” or “third party providers,” collectively referred to as “advertiser(s),” refers to the initiator and evaluator of the addressable advertisement and alert messages; these include, but are not limited to: merchants, brands, entrepreneurs, groups, individuals, schools, newspaper publishers, magazines, ad networks, ad servers, ad agencies, coupon clearing houses, non-profit organizations, other third party entities; and foreign or domestic national, state, county, and local government entities (and their foreign equivalents); and wireless carriers, and the like. It is possible that the initiator and evaluator can be different entities.

The term “lock screen display” refers to the screen display seen upon waking up a mobile device from sleep mode by engaging a logical or physical input key. The lock screen display is only seen during the period between wake-up of the mobile device and unlocking of the mobile device.

The term “render” refers to compose, draw, express, build, present visually or non-visually, animate, or otherwise portray artistically.

The term “Content Delivery System” refers to the system components where advertisement or alert messages are created, stored, and formatted prior to transmission to the communication service provider for delivery to an addressable mobile device user and where the response to the message sent is measured and analyzed.

The terms “advertisement”, “ad”, “message”, “ad message”, “alert message”, “message template”, or “message content” each refer to a pre-packaged, three-part message (Parts A, B, and C) created, customized, modified, or enhanced by software developers via the software development kit and by advertisers via a web portal to create advertisement or alert messages that are rendered using the mobile device's capabilities.

The term “Part A” is a package of software code and associated files as created by a software developer via the software development kit, which package provides the Content Message Layer instructions on how to render an advertisement or alert message utilizing the mobile device's capabilities.

The term “Part B” is a package of software code, metadata, and associated files, as created, modified, or enhanced by a software developer via the software development kit, and as customized by the advertiser via a web portal, which package provides the Content Message Layer instructions on what to render as an advertisement or alert message utilizing the mobile device's capabilities.

The term “Part C” refers to digital elements pre-stored in the Content Message Layer that are tools, objects, rich media, data, audio files, and/or other digitized elements to be used to render an advertisement or alert message utilizing the mobile device's capabilities.

The term “Learn More” or “Learn More Attributes” refers to attributes defined by the advertiser that provide a means for the mobile device user to interact and engage with the advertiser and/or other mobile device users, to become informed about the advertisements or alert messages, and to actually purchase their product or service.

The term “Explicit Manager” refers to computer executable language manufactured, installed, modified, integrated, bundled, configured, or otherwise designed into the operating system that enables the rendering of the advertisement or alert message and the mobile device user's interaction with the rendering message. The “Explicit Manager” is a module of the Content Message Layer that captures and stores the mobile device user's engagement with advertisements or alert messages, including the Learn More attributes.

The term “Implicit Manager” refers to a module of the Content Message Layer that is a computer executable language manufactured, installed, modified, integrated, bundled, configured, or otherwise designed into the operating system that captures and stores any device collectable data indirectly linked to advertisers.

The term “Mobile Message Protocol” (“MMP”) refers to a formatted data package to transport messages to and from mobile devices using existing communication service provider's network and protocols.

The term “Companion Page” or “Offer Page” refers to an attribute of the learn more attributes, a sub-set of the message template; where the advertiser presents the essence of the ad message, and its definition is crafted by the advertiser.

The term “Digital Resource Center” or “DRC” refers to a component of the Content Message Layer that stores tools, objects, rich media, data, audio files, elements of Part C, and/or other digitized elements to be used by other elements of the Content Message Layer.

The term “User Profile Cookie” refers to a specialized internet cookie manifested and controlled by the mobile device user and with permission is dispensed to affiliated internet web sites.

The term “first triggering event” refers to an event that causes the mobile device to wake from the sleep mode.

The term “second triggering event” refers to an event that is a representation of the mobile device user going to the next step in the advertiser's message and/or rendering process.

The term “Inbound Message” refers to messages that are transmitted to the mobile device.

The term “Outbound Message” refers to messages that are transmitted from the mobile device to affiliated content servers.

### DETAILED DESCRIPTION

Referring now to the figures, an example system including the components of the Message Delivery Ecosystem (MDE) 1000: the Content Delivery System (CDS) 1200; the Mobile Message Protocol (MMP) (a protocol for communication service provider (PCSP)) 1300; and the Content Message Layer (CML) 1500 on the mobile device 1400 will be described.

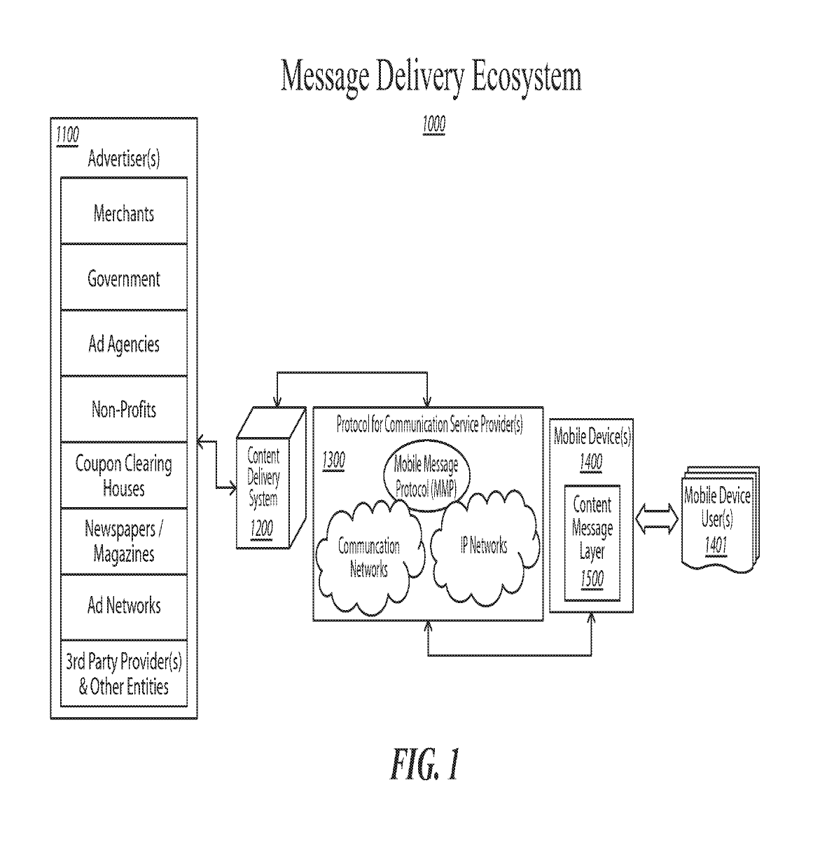

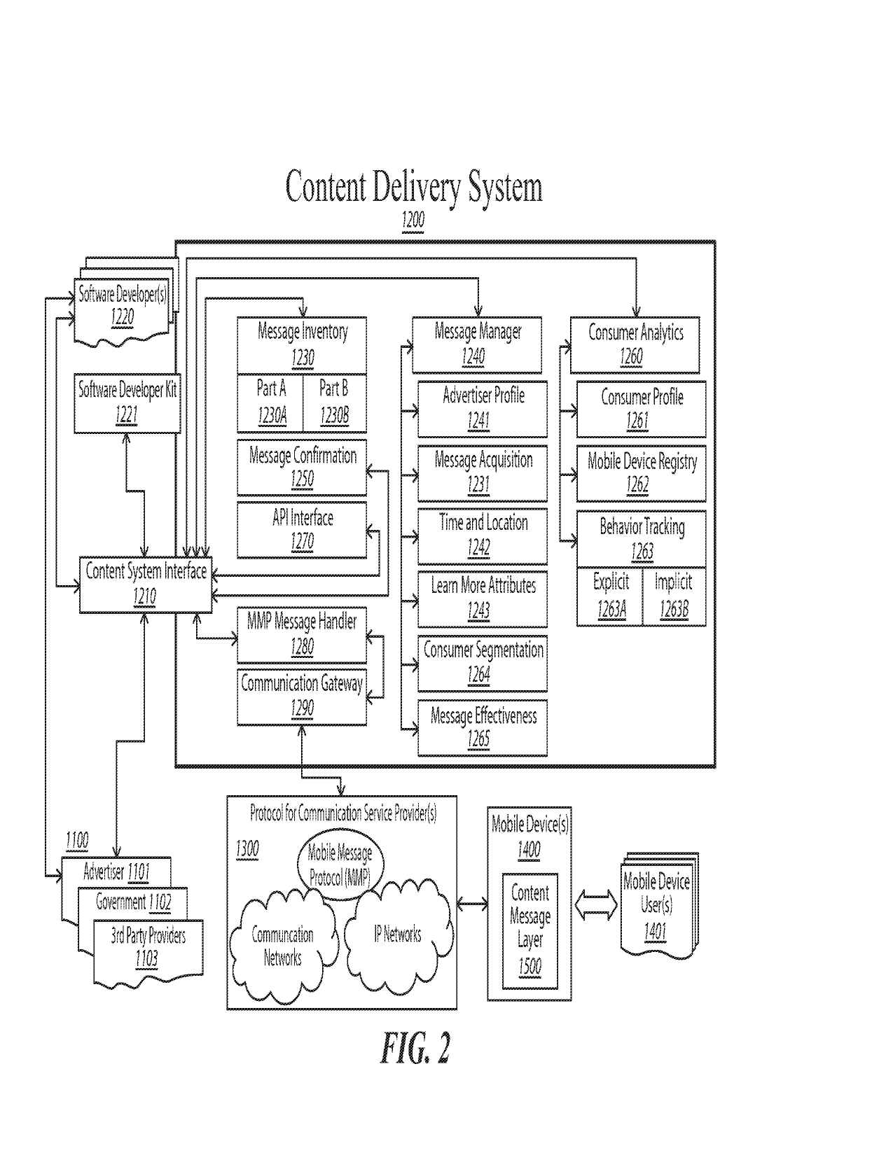

Message Delivery Ecosystem—FIG. 1 illustrates the functionality and methods of the example MDE 1000 and each of its three components. The MDE 1000 effects the ability to create, transport, store, render, capture, and measure addressable messages from one group 1100 (the advertisers) to another group 1401 (the mobile device users), on a mass scale. The CDS 1200 are system components where ad messages or alert messages are created, stored, and formatted prior to transmission through the communication service provider for delivery to an addressable mobile device user 1401 via one or more mobile devices 1400; and where the sent message responses are measured and analyzed by the initiator 1100 (advertiser). The PCSP 1300 is a formatted data package to transport messages to and from mobile devices 1400 using existing communication service provider's network and protocols. The CML 1500 is an apparatus manufactured, integrated, bundled, configured, modified, installed, or otherwise designed into the operating system of the mobile device 1400. Once manufactured, integrated, bundled, configured, modified, installed, or otherwise designed, the mobile device 1400 can receive, store, render, capture and retransmit trackable responses to ad messages or alert messages back to the CDS 1200 using the PCSP 1300.

Content Delivery System—Referring to FIG. 2, this figure illustrates an example embodiment of the CDS 1200. The CDS 1200 consists of web portals, file servers, relational databases, software developers 1220, advertisers 1100, PCSP 1300, mobile devices 1400, and mobile device users 1401. The web portals are: Consumer Profile 1261, Advertiser Profile 1241, Mobile Device Registry 1262, Message Manager 1240 (and related functionality), and Software Development Kit (SDK) 1221. The file servers include: Content System Interface 1210, MMP Message Handler 1280, Communication Gateway 1290, API Interface 1270, and Message Confirmation Server 1250. The CDS 1200 also consists of several large databases: Message Inventory 1230, Behavior Tracking 1263, and Consumer Analytics 1260.

Collectively, FIG. 2 illustrates the CDS 1200 as one complex system with many logical and physical attributes. The content system interface 1210 merely represents the interaction within the CDS 1200 and provides a simplified view of how all logical and physical connections and interaction among and between the sub-elements of the CDS 1200 communicate.

The CDS 1200 has many embodiments and some are detailed herein; there are five preferred embodiments: the first is the software developer's 1220 view; the second is the advertiser's 1100 view (all advertisers 1101, government 1102, but excluding third-party providers 1103); the third is the government's 1102 view (additional functionality for government and wireless carriers only); the fourth is the view from using APIs 1270 (third-party providers 1103); and the fifth is the mobile device user's 1401 view. These views are presented to illustrate the different perspectives of the CDS 1200 and how the various sub-elements are deployed and how they subsequently interface with the PCSP 1300 and the CML 1500.

Content Delivery System 1200 (Software Developer's 1220 View)—Sub-elements of FIG. 2 illustrates the viewpoint from software developer 1220. Software Developer Kit (SDK) 1221 is a web based tool to create ad messages and alert system messages in the form of message templates to be stored in the message inventory 1230. Another embodiment of the SDK 1221 is a downloaded tool that can be used directly on a software developer's 1220 computer and then the finished message template can be uploaded into the message inventory 1230. The SDK 1221 provides a method to create messages that take advantage of the mobile device's 1400 capabilities for rendering and interaction purposes. Once the message template has been created, the SDK 1221 will automatically parse and format elements of the message template into three packages: Part A 1230A, Part B 1230B and Part C. Part A 1230A is a package of software code and associated files which provide the CML 1500 instructions on how to render and enable the mobile device user 1401 to interact with an ad message or alert message utilizing the mobile device's 1400 capabilities. Part B 1230B is a package of software code, metadata, and associated files which provide the CML 1500 instructions on what to render as an ad message or alert message utilizing the mobile device's 1400 capabilities. Part C are digital elements pre-stored in the CML 1500 that are tools, objects, rich media, data, audio files, physics engine elements, and other digitized elements for rendering purposes. Part A 1230A is larger in size than Part B 1230B and is transmitted separately from Part B 1230B, usually during non-peak, lower network volume periods for the communication service provider 1310. Part B 1230B is a smaller data packet and can be transmitted closer to the advertiser's 1100 selected time for execution. The CML 1500 receives both parts and stores them separately for subsequent rendering.

In this illustration of the SDK, the SDK 1221 compares rendering components in Part A's 1230A message template against the mobile devices 1400 registered in the mobile device registry 1262. The mobile device registry 1262 contains mobile device's 1400 capabilities native to each registered mobile device 1400. This comparison will provide the software developer 1220 information about the compatible mobile devices 1400 that are fully able to render their messages. This comparison ultimately determines the reach of their message template; thus quantifying what percentage of the mobile devices 1400 that can render their message. Based on this comparison, the software developer 1220 could then modify their message template to increase the percentage of compatible mobile devices 1400.

Content Delivery System 1200 (Advertiser's 1100 View)—Sub-elements of FIG. 2 illustrate the viewpoint from the advertiser 1100—all advertisers 1101, government 1102, but excluding third-party providers 1103 (see View Used by APIs). The message templates used by the advertiser 1100, called ad messages, are illustrated in this embodiment. In this embodiment, the advertiser profile 1241 contains account billing information about the advertiser 1100, general company information, detailed product and service information, and metadata used to populate select learn more attributes 1243 for ad messages.

The message manager 1240 provides the advertiser 1100 access and control of their ad message inventory 1230; to which consumer segment 1264 the message is addressed and sent; delivery elements of time and location 1242 of when and where the message is rendered; definition of each learn more attributes 1243 responses the advertiser 1100 wants the mobile device user 1401 to know, experience, or learn (exposure); and quantifiable measurement factors as to whether the ad message was actually delivered (message confirmation 1250) to the addressed mobile device 1400 and the overall message effectiveness 1265, as enumerated by which and how many learn more attributes 1243 responses the mobile device user 1401 actually engaged.

The advertiser 1100 can either create their own ad message using internal or external software developers 1220, or they can acquire ad message created by third-party software developers 1220 or acquire standard, pre-made ad messages. All ad messages are stored in the message inventory 1230 and are managed and acquired by the message acquisition 1231.

The advertiser 1100 uses the consumer segmentation 1264 to view the consumer analytics 1260, to select and refine targeted consumer group(s) to satisfy their business need, or to fulfill the needs of an ad campaign. Even though none of the mobile device user's 1401 personally identifiable information is accessible to the advertiser 1100; the advertiser 1100 uses the consumer analytics 1260 to ascertain desirable consumer segments for targeting purposes. The consumer analytics 1260 is a compilation of self-reported consumer profile 1261 information obtained directly from the mobile device user 1401 and that is then married with explicit and implicit behavior tracking 1263 information; derived directly and indirectly from the mobile device user's 1401 exposure and interaction with advertisers 1100 and the ad messages addressed, sent and received by the CML 1500.

Once the desired targeted consumer group is selected, the advertiser 1100 identifies the time and location 1242 considerations for sending the ad message to the mobile device 1400. The CML 1500 receives and stores the addressed ad message and does not render it until time and/or location considerations are satisfied. If the time and/or location considerations are not satisfied, the CML 1500 sends this disposition to the message confirmation 1250, and subsequently this disposition is presented to the advertiser 1100 in the message effectiveness 1265. Likewise, if the time and/or location considerations are satisfied, and the ad message is rendered, the CML 1500 also sends this disposition to the message confirmation 1250, and subsequently this affirmative disposition is presented to the advertiser 1100 in the message effectiveness 1265.

Still using the message manager 1240, the advertiser 1100 authorizes the acquired ad message to be sent, based on time and location 1242 considerations, to the targeted consumer segmentation 1264, and then ultimately arriving at the addressed mobile device 1400 associated with the mobile device user 1401 within the consumer segmentation group. The linking methodology to achieve this starts by assigning the advertiser 1100 a unique identification number (ID) in the advertiser profile 1241; assigning the mobile device user 1401 an identification number in the consumer profile 1261; assigning the mobile device 1400 a unique identification number in the mobile device registry 1262; and then assigning the ad message to be sent its unique identification number in the message inventory 1230. Accordingly, the mobile device registry 1262 also ties the registered mobile device 1400 directly to an affiliated communication service provider. Consequently, when the advertiser 1100 authorizes the ad message to be sent, the message manager 1240 uses the appropriate identifiers as a method to send specific ad messages to specific mobile devices 1400; this is first processed through the MMP message handler 1280 and then through the communication gateway 1290 for a specific communication service provider to transport to the mobile device 1400, then ultimately on to the assigned mobile device user 1401.

The MMP message handler 1280 formats, packages, and encrypts the ad message, message ID, mobile device 1400 ID, mobile device user 1401 ID, and the advertiser ID; according to the PCSP 1300. The communication gateway 1290 is configured for each separate communication service provider. The mobile device 1400 ID designates which communication service provider is affiliated to each mobile device 1400 and the communication gateway 1290 uses this ID to process the ad message to the appropriate communication service provider. This aforementioned method explains the process that the message manager 1240 uses to determine which ad message is sent through to a specific communication service provider, and to be subsequently delivered to a specific mobile device 1400. The CML 1500 has an authentication methodology for accepting or rejecting ad messages that do not match the mobile device 1400 ID and the mobile device user 1401 ID against those same defaulted values in the CML 1500.

All CDS 1200 outbound and inbound transmissions from the content system interface 1210 are processed through both MMP message handler 1280 and the communication gateway 1290.

One additional composition variable of the ad message is for the advertiser 1100 to define the elements of the learn more attributes 1243 that are associated with the ad message. These learn more attributes 1243 provide a means for the mobile device user 1401 to interact and engage with the advertiser 1100 and/or other mobile device users 1401, to learn more about the ad message sent, share, as well as, to actually purchase their product or service. The first learn more attribute 1243 is the companion page and this page or section of the lock screen display, is rendered immediately after a second triggering event. The companion page is also referred to as the offer page; where the advertiser 1100 presents the essence of the ad message; its definition is crafted by the advertiser 1100 in the learn more attribute 1243. Additional learn more attributes 1243 are also defined by the advertiser 1100 and are comprised of web links and other means to convey and share information which are tailored to a specific ad message, provides additional information to the mobile device user 1401 about the subject of the ad message, the product, service or brand. Examples of additional information are, but not limited to: a video, press release, an audio file, a website, map or location, survey questions, product reviews, price comparison, call the merchant, email, text, search for related products, add to a shopping list, add to a gift or wish list, mobile ahead purchases or restaurant reservations, convert to a redeemable coupon, or share through a social venue. Many of these learn more attributes 1243 could be the same across the advertiser's 1100 products and services, as found in the advertiser profile 1241, and are appended and managed using the learn more attributes 1243 and then are subsequently linked to an ad message using the message ID. Once defined and linked to a message ID, the learn more attributes 1243 become a subset of the Part B 1230B ad message, and the CML 1500 subsequently processes each attribute using consistent methodologies.

The advertisers 1100 use the message effective 1265 functionality to assess and evaluate the successfulness of their current advertisement; a key element provided is the message confirmation 1250 that the ad message was delivered and rendered. This information along with other information provided, aids the advertiser 1100 in determining what could be their next action step in running their ad campaigns.

Collectively, this embodiment of the CDS 1200 provides methods for the advertisers 1100 to have a closed-loop conversation with each anonymous addressed mobile device user 1401. This embodiment is illustrated by linking the advertiser's 1100 unique ID to the ad message ID and to the mobile device user 1401 ID, and then creating closed-loop transactions to and from the CML 1500. Consequently, as each ad message is sent, interacted with, or shared by the addressed mobile device user 1401, all three unique IDs are tracked at every step of the CDS 1200 process. Subsequently, the consumer analytics 1260 collects data from the CML 1500 into three buckets: ad messages, advertisers 1100, and mobile device user 1401 (each anonymous mobile device user 1401 is aggregated with like profiles and behavior to constitute organically formed, unique consumer segments). Each ad message sent (inbound to the CML 1500) and ad message response (outbound from the CML 1500) contains these unique identifiers and ultimately correspond to one embodiment of the consumer analytics 1260 structure.

All explicit 1263A and implicit 1263B behavior data collected by the CML 1500 are similarly identified with these same identifiers. The consumer analytics 1260 compiles and organizes this data to create multiple views for analysis by the advertisers 1100. There are numerous embodiments of this data; the following are just three:

Ad Message Centric View—Every ad message sent to every mobile device user 1401 by every advertiser 1100 creates the first view. Using the ad message effectiveness 1265 measurement ascertained from mobile device users 1401 engaging in the various learn more attributes, the consumer analytics 1260 is able to rank the effectiveness of every ad message sent in the database. This data is then parsed by: industry, sector, geography, product group, individual product, advertiser 1100, online, brick and mortar, consumer segmentation 1264, and more. This view creates a method to rank overall ad message effectiveness across all ad messages in the database.

Advertiser 1100 Centric View—Every ad message sent to every mobile device user 1401 by each advertiser 1100 creates the second view. Using the same ad message effectiveness 1265, the consumer analytics 1260 is able to similarly rank every ad message sent by each advertiser 1100 to every consumer segment 1264. Likewise, the consumer analytics 1260 is then able to parse the data by: industry, sector, geography, product group, individual product, online, brick and mortar, consumer segment 1264, and more. This view is a method for the advertiser 1100 to determine which ad campaigns were effective and which were not. Additionally, a method for overall brand ranking of all the advertisers 1100 is readily available.

Consumer Centric View—Every ad message sent by every advertiser 1100 to each consumer segment 1264 creates the third view. Using the same ad message effectiveness 1265, the consumer analytics 1260 is able to similarly rank every ad message sent by every advertiser 1100 to each consumer segment 1264. Likewise, the consumer analytics 1260 is then able to parse the data by: industry, sector, geography, product group, individual product, online, brick and mortar, and more. This view is a method for determining which ad messages the mobile device user 1401 best responds, what products and services they are most interested in, and which advertisers 1100 they view in high or low regard.

These views provide multiple methods to assess and evaluate the return of the advertiser's 1100 dollar spent. Advertisers 1100 using these multiple methods can illuminate the targeted consumer's unique interests and needs, which then provide the advertiser 1100 actionable insight to further discover what matters and what is relevant to the mobile device user 1401. Also, these methods provide tools for the advertiser 1100 to find new prospects for their products and services. Once the new prospects have been identified, the advertiser 1100 can use the closed-loop conversation method to help nurture the relationship from being new prospects to become long-term loyal customers. Ultimately, the CDS 1200 gives the advertiser 1100 more data and methods for assessing market opportunity while also giving them new methods for creating long-term value, through delivering more relevant and responsive ad messages.

The following paragraphs provide an illustration of a closed-loop conversation between an advertiser 1100 and a targeted consumer segment 1264; and how a method for using the consumer analytics 1260 can assist the advertiser 1100 in moving new prospects into becoming long-term loyal customers. This illustration is of an outdoor camping advertiser 1100 executing an ad campaign for an end-of-summer clearance sale.

To start, let's assume there are one million mobile device users 1401 nation-wide with mobile devices 1400. The outdoor camping advertiser 1100 first selects the geographical area of metropolitan Washington D.C.; the message manager 1240 presents there are 10,000 mobile device users 1401 in the area. Next the advertiser 1100 selects ‘enjoys outdoor activities’ consumer segmentation 1264, the message manager 1240 presents 1,000 profiled mobile device users 1401 that enjoy outdoor activities. For privacy concerns, the mobile device user's 1401 name, mobile number, address, or any other identifiable attributes are never disclosed to the advertiser 1100; however, the advertiser 1100 does know definitively—there are 1,000 real people in the Washington area who enjoy outdoor activities—the advertiser's 1100 target audience for their end-of-summer clearance sale.

For simplicity sake, let's assume that all 1,000 mobile device users 1401 received the end-of-summer ad message. Out of those 1,000, only 100 mobile device users 1401 engaged the ad message and converted the ad message into a digital coupon (a choice of the learn more attributes 1243) and then ultimately bought a tent. Through a function of the learn more attributes 1243, the CML 1500 is able to track those purchases using the digital coupon. A second group of mobile device users 1401, 200 of them, received the ad message, engaged in a variety of learn more attributes 1243—however, did not buy anything. And finally, the third group, 700 users, were merely exposed to the ad message and did not engage in any learn more attributes 1243.

With three weeks left to the end of the sale, the advertiser 1100 decides to send out a second ad message. Using the specific knowledge of each group's responses from the consumer analytics 1260, the advertiser 1100 is able to have a distinctive progressive conversation; thus the advertiser 1100 does not send the same ad message to the same 1,000 mobile device users 1401. Instead, the advertiser 1100 crafts three separate follow up second ad messages, each relevant and responsive to the mobile device user's 1401 previous ad message response and interaction. To the first group, who bought a tent, an ad message thanking them and incenting them to buy tent accessories. To the second group, engaged but didn't buy anything, an ad message that included more information about features and benefits. And to the last group, the ones that did not respond to the ad message, an ad that is a little more innovative about getting their attention. This progressive conversation, mindful of the mobile device user's 1401 previous response, could continue, with several iterations, until the tent sale has concluded.

This illustration of the CDS 1200 closed-loop conversation, similar to direct selling, provides the advertiser 1100 with actionable insights (methods) to inform the advertiser 1100 of what to say and/or do next in their ad campaign. These methods assist the advertiser 1100 to evolve their ad messages to help move the mobile device user 1401 to become a long-term loyal customer and to ultimately strengthen the market position.

Content Delivery System 1200 (Government's 1102 View)—Sub-elements of FIG. 2 illustrate the viewpoint from the government 1102 (foreign or domestic national, state, county, and local government entities (and their foreign equivalents), and wireless carriers). This view has two embodiments: first as a regular advertiser 1100 and second as a government 1102 entity. Within the first, as a regular advertiser 1100, they deploy the same systems, methods and apparatus as discussed in paragraphs [0091] to [0111] above. The second embodiment addresses the government's 1102 role as part of the Emergency Alert System and/or other alert messaging requirements.

The Emergency Alert System (EAS) is a U.S. national public warning system that requires broadcasters, cable television systems, wireless cable systems, satellite digital audio radio service (SDARS) providers, and direct broadcast satellite (DBS) providers to provide the communications capability to the President of the United States to address the American public during a national emergency. The system also may be used by state and local authorities to deliver important emergency information, such as AMBER alerts and weather information targeted to specific areas. This embodiment addresses the foreign or domestic national, state, county, and local government entities (and their foreign equivalents), and wireless carriers as a collective entity and it illustrates how the CDS 1200 provides a new communication method for delivering important alert information.

The same systems, methods and apparatus as discussed above for all advertisers 1100, also are deployed in this embodiment, plus four additional distinctions that are unique to the EAS: first, alert message used only by the government 1102; second, the ability to prioritize the alert message delivery to supersede all other messages; third, the ability to render the alert message without a first triggering event; and fourth, a specialized API interface with the CML 1500 for establishing two-way communication.

The message templates used only by the government 1102, called alert messages, are illustrated in this embodiment. These alert messages are standardized and preinstalled into the CML 1500 at manufacture or via firmware upgrade or at the device fulfillment vendor premises or through other system updates. The preinstalled alert messages are only Part A 1230A of the two part alert message; Part B 1230B will be transported as dictated by government 1102 requirements. The CML 1500 contains segregated storage for these alert messages; and new messages or existing messages can be added, modified or deleted at any time by the government 1102 using the message manager 1240 and SDK 1221. Additionally, the U.S. Government 1102 has established a Common Alert Protocol (CAP) for disseminating alert messages across multiple channels. The API interface 1270 will process these messages automatically, without human intervention.

The ability to prioritize the message delivery to supersede all other messages is functionality available only to government 1102 entities, and is illustrated in this embodiment. Among the government 1102 entities is a pre-determined hierarchy for which entity has message priority over another, e.g., the President over a local authority; and this hierarchy structure is stored in the advertiser profile 1241 and then processed by the message manager 1240. The message manager 1240 or the API interface 1270 processes the message priority status onto designated alert messages, transmits through the PCSP 1300 to the CML 1500 within the mobile device 1400 and then subsequently, the alert message is rendered based on this designation. Consequently, based on message priority designation, alert messages may be scheduled to be rendered before any other message in the message queue in the CML 1500; or scheduled to be rendered at a specific time, regardless of the other messages in the message queue; or scheduled to be rendered based on a specific location, regardless of the other messages in the message queue; or scheduled to be rendered at a specific time and location 1242, regardless of the other messages in the message queue.

The ability to render the message without a first triggering event is illustrated in this embodiment. This enables the government 1102 to transmit alert messages and have those messages rendered without a first triggering event. Other messages generally require a first triggering event before any message is rendered. Only the government's 1102 alert message can be rendered without a first triggering event. The designation of which alert messages can be rendered without a first triggering event is also included in the message priority in Part B 1230B of the alert message. The establishing, processing and rendering of this designation uses the same methods as described in the previous paragraph.

A specialized API interface within the CML 1500 for establishing two-way communication is illustrated in this embodiment. This enables the government 1102, via the API interface 1270, to communicate with the API interface within the CML 1500 of the mobile device 1400 to engage the mobile device's 1400 capabilities to establish two-way communication between the mobile device 1400 and the government 1102 entity.

Content Delivery System 1200 (View Using APIs)—Sub-elements of FIG. 2 illustrate the view using APIs. In this embodiment, an application programming interface (API) is a source code-based specification intended to be used as an interface by software components to communicate with each other. An API may include specifications for routines, data structures, object classes, and variables. The API interface 1270 provides a software component for the CML 1500 to communicate with the content system interface 1210 and back, as well as, for outside entities to communicate with the content system interface 1210. There are multiple embodiments to the API interface 1270, but only four are illustrated herein: first, third-party applications installed on the mobile device 1400 requesting ad messages 1230 to be sent to the mobile device 1400 for independent rendering by third-party applications; second, third-party applications installed on the mobile device 1400 requesting consumer segmentation 1264 or consumer analytics 1260 data to be sent to the mobile device 1400 for consumption by the third-party application; third, third-party providers 1103 repurposing their digital advertising content to send select ad messages from the message inventory 1230 to the mobile device 1400; and fourth, the government 1102 to send CAP alert messages to the mobile device 1400.

The APIs for third-party applications installed on the mobile device 1400 to request an ad message from the message inventory 1230 to be sent to the mobile device 1400 for independent rendering is illustrated in this embodiment. The code-based interface starts when the third-party application using a unique API identifier assigned to the application, utilizes the CML 1500 to send a request to the API interface 1270, via the PCSP 1300. The request is for a specific ad message ID to be retrieved from the message inventory 1230. Upon retrieval, the API interface 1270 using the API identifier and other identifiers subsequently sends the requested ad message back through the PCSP 1300 to the CML 1500, where the third-party application independently renders the ad message. The CML 1500 separately tracks the mobile device user's 1401 response and interaction to the rendered ad message; this explicit behavior is linked to the same API identifier in the CML 1500. The stored explicit behavior is subsequently transmitted back through the PCSP 1300 to the behavior tracking 1263A.

The APIs for third-party applications installed on the mobile device 1400 requesting consumer segmentation 1264 or consumer analytics 1260 data to be sent to the mobile device 1400 for consumption by the third-party application is illustrated in this embodiment. The code-based interface starts when third-party application using a unique API identifier assigned to the application, utilizes the CML 1500 to send a request to the API interface 1270, via the PCSP 1300. The request is for specific consumer segmentation 1264 or consumer analytics 1260 data. Upon retrieval, the API interface 1270 using the API identifier subsequently sends the requested consumer segmentation 1264 or consumer analytics 1260 data back through the PCSP 1300 to the CML 1500, where the third-party application independently processes the information sent. The CML 1500 separately tracks the mobile device user's 1401 response and interaction to the rendered ad message; this explicit behavior is linked to the same API identifier in the CML 1500. The stored explicit behavior is subsequently transmitted back through the PCSP 1300 to the behavior tracking 1263A.

The APIs for third-party providers 1103 (including select advertisers 1101 and government 1102 with automated interfaces) to repurpose their digital advertising content to send select ad messages 1230 to the mobile device user 1401 is illustrated in this embodiment. The code-based interface enables third-party providers 1103 to send preformatted digital advertising content to the API interface 1270 for packaging and processing. The API interface 1270 utilizes default ad messages from the message inventory 1230 and sends the ad message to predetermined consumer segmentation 1264 groups. Both time and location 1242 delivery elements are limited by the API interface 1270, consequently the CML 1500 schedules these messages for delivery to the mobile device user 1401 after other advertisers 1100 do not have a message scheduled to be rendered; these third-party provider's 1103 digital advertising content ad messages are rendered to fill unused time blocks and remnant inventory. Other than the exceptions noted above, the third-party providers 1103, deploy the same systems, methods and apparatus as discussed in paragraphs [0091] to [0111] above.

The APIs for the government 1102 (excluding all other advertisers 1101 and third-party providers 1103) to send CAP alert messages to the mobile device user 1401 is illustrated in this embodiment. The code-based interface enables government 1102 to send preformatted alert messages to the API interface 1270 for packaging and processing. The API interface 1270 utilizes default ad messages from the message inventory 1230 and sends the ad message to predetermined consumer segmentation 1264 groups. Other than the exceptions noted above, the government 1102 deploys the same systems, methods and apparatus as discussed in paragraphs [0091] to [0111] above.

Content Delivery System 1200 (Mobile Device User 1401 View)—Sub-elements of FIG. 2 illustrate the viewpoint from the mobile device user 1401. In this embodiment, the mobile device user 1401 administers his or her consumer profile 1261, the content and privacy aspects of their explicit 1263A and implicit 1263B tracked behavior in the behavior tracking 1263, the content and authorization of their personalized internet cookie, and the loyalty aspects of their consumer profile information. Also in this embodiment, the consumer profile 1261 and the mobile device registry 1262 create an identity authentication method in the CML 1500.

In this embodiment, the consumer segmentation 1264 is derived from direct input information from individual mobile device users 1401 through a web portal to the consumer profile 1261 and from the explicit 1263A and implicit 1263B tracked behavior captured by the CML 1500 on their mobile devices 1400. Together, the consumer segmentation 1264 information is a rollup of anonymous liked-profiled and tracked individuals—real people, organically aggregated, one-by-one into a database.

The authenticity and accuracy of the consumer segmentation 1264 information is illustrated by providing transparency and control of the individual's consumer profile 1261 to author and originator of the information—the mobile device user 1401. This is further illustrated by the mobile device user 1401 accessing his or her individual consumer profile 1261 through a web portal and enabling the mobile device user 1401 to enter in new profile information, modify existing information and/or delete any aspect of the profile information, at any frequency. This is even further illustrated by providing the mobile device user 1401 a transparent view of the tracked explicit 1263A and implicit 1263B items in the behavior tracking 1263. In this embodiment, the consumer profile 1261 presents to the mobile device user 1401 how the behavior tracking 1263 views him or her. The behavior tracking 1263 provides a method for the mobile device user 1401 to use his/her recent behaviors to act as a navigation tool and show how those behaviors contribute to his/her profile. Each attribute reflects an inferred interest according to their recent behavior. The mobile device user 1401 can either change the behavior tracking 1263 to ‘track it’ and elevate the inferred segment or topic into a declared interest, or to ‘delete it’ and eliminate the item from the behavior tracking 1263. Alternatively, the mobile device user 1401 just leaves the tracking results as they were.

Collectively, these embodiments provide methods for the mobile device user 1401 to control the content of what resides in the behavior tracking 1263 about them and the ability to delete or modify any item they deem private or do not want tracked or used for targeted advertising purposes. Furthermore, these embodiments illustrate methods for the mobile device user 1401 to be the catalyst for organically self-defined and naturally generated consumer segments 1264 to be created, which are all derived, maintained and controlled by individual mobile device users 1401. This embodiment of the consumer segmentation 1264 provides the advertisers 1100 a method to identify real but anonymous people (mobile device users 1401) via the self-defined consumer segmentation 1264, to address and send contextually relevant ad messages based on this self definition, subsequently assess the individual and collective responses to those messages using the behavior tracking 1263, and then send reiterative ad messages based on the mobile device users 1401 previous message responses. This embodiment is another illustration of having a closed-loop progressive conversation using responsive ad messages.

In this embodiment, the mobile device user 1401 uses the consumer profile 1261 to administer a personalized internet cookie that they define and control. Conventionally, internet cookies are used to remember the information about the internet user who has visited a website in order to show relevant content in the future. Often, the relevant content is in the form of display advertisement on the web pages subsequently visited by the internet user. In this embodiment, a personalized internet cookie is manifested and authorized by the mobile device user 1401 to be used by the mobile device's 1400 internet browser to facilitate personalized display advertisement on the web pages visited by the mobile device user 1401 from his or her mobile device 1400. In this illustration, using the consumer profile 1261, the mobile device user 1401 has a collective view of his or her profile information combined with his or her tracked explicit 1263A and implicit 1263B behavior information. This collective view is a representation of the mobile device user's 1401 personalized internet cookie. Using the consumer profile 1261 as illustrated in paragraphs [0126] to [0127] to define and maintain his or her individual profiles and tracked behavior information, the mobile device user 1401 effects the manifestation and control over his or her personalized internet cookie. As a further illustration, using the consumer profile 1261 the mobile device user 1401 may elect authorization of his or her personalized internet cookie. If authorized, the consumer profile 1261 processes the mobile device user's 1401 personalized internet cookie through the PCSP 1300 to the CML 1500 for use by the mobile device user 1401.

In this embodiment, loyalty aspects of the mobile device user's 1401 profile information and tracked behavior are made transparent and can be administered. Generally, loyalty programs are structured marketing efforts that reward, and therefore encourage, loyal buying and other behavior—behavior which is potentially beneficial to the advertiser. In this illustration the consumer profile 1261 provides the mobile device user 1401 a transparent view of which advertisers 1100 are associated with each aspect of their profile information and their explicit 1263A and implicit 1263B tracked behavior; and provides the mobile device user 1401 the ability to delete existing associations or to create new associations with advertisers 1100. This associated linkage is derived from the advertiser's 1100 identification number entered into each ad message sent to the mobile device user 1401 and to the advertiser's 1100 identification number captured and tracked in the mobile device user's 1401 subsequent explicit 1263A and implicit 1263B behavior. In this illustration, the name of the advertiser 1100 will be presented when an attribute of the mobile device user's 1401 profile information is associated with an advertiser's 1100 identification number. Also, in this illustration, the name of the advertiser 1100 will be presented when an attribute of the mobile device user's 1401 explicit 1263A and implicit 1263B behavior is associated with an advertiser's 1100 identification number. Using the consumer profile 1261, the mobile device user 1401 can administer the loyalty aspects of their profile information by: viewing the loyalty program elements associated with an advertiser 1100 linked to each attribute, and then deleting an existing association with an advertiser 1100, or creating a new association with an advertiser 1100.

In this embodiment, an additional privacy safeguard is created by issuing the mobile device user 1401 a unique identification number. This mobile user ID is assigned by the consumer profile 1261 upon initiation and is used throughout the CDS 1200 when addressing the mobile device user 1401. The unique identification number is for keeping the mobile device user 1401 anonymous.

In this embodiment, the mobile device user 1401 administers his or her mobile device registry 1262. The mobile device registry 1262 is derived from direct input information from mobile device users 1401 through a web portal assigning their mobile device's 1400 affiliation with the CDS 1200. The mobile device user 1401 may affiliate one or more mobile devices 1400 to the CDS 1200 and each device is assigned a unique mobile device 1400 identification number. These mobile devices' 1400 IDs are portable and can be transferred to and from mobile device users 1401. Through the consumer profile 1261 the mobile device user 1401 administers this linkage between mobile device(s) 1400 and himself or herself, as well as, the linkage between the mobile device(s) 1400 and their affiliated communication service provider. This embodiment illustrates the method used to link one or more mobile devices 1400 to a single mobile device user's 1401 consumer profile 1261 and to link each mobile device 1400 to a communication service provider. This further illustrates the method to collect behavior tracking information 1263 from multiple mobile devices 1400, each tied to a single consumer profile 1261 and mobile device user 1401. Additionally, this illustrates the method used for determining which communication service provider to address the ad message for transmission to reach the mobile device user 1401.

In this embodiment, the consumer profile 1261 and the mobile device registry 1262 create an identity authentication method in the CML 1500. After the mobile device 1400 identification number has been established in the mobile device registry 1262, this mobile device 1400 ID and corresponding mobile device user 1401 identification number is transmitted through the PCSP 1300 to the CML 1500 on the registered mobile device 1400. Both of these identification numbers are stored in the CML 1500 and are used to authenticate future content system interface 1210 transmissions addressed to the mobile device 1400. Each subsequent ad message, alert message or API message transmission sent from the content system interface 1210 through the PCSP 1300 contains both the mobile device 1400 and the mobile device user's 1401 identification numbers. Upon receipt of each transmission, the CML 1500 uses the store identification numbers to validate against the received transmission. If the authentication fails, the transmission is rejected and if the authentication is satisfied, the transmission is accepted and processed.

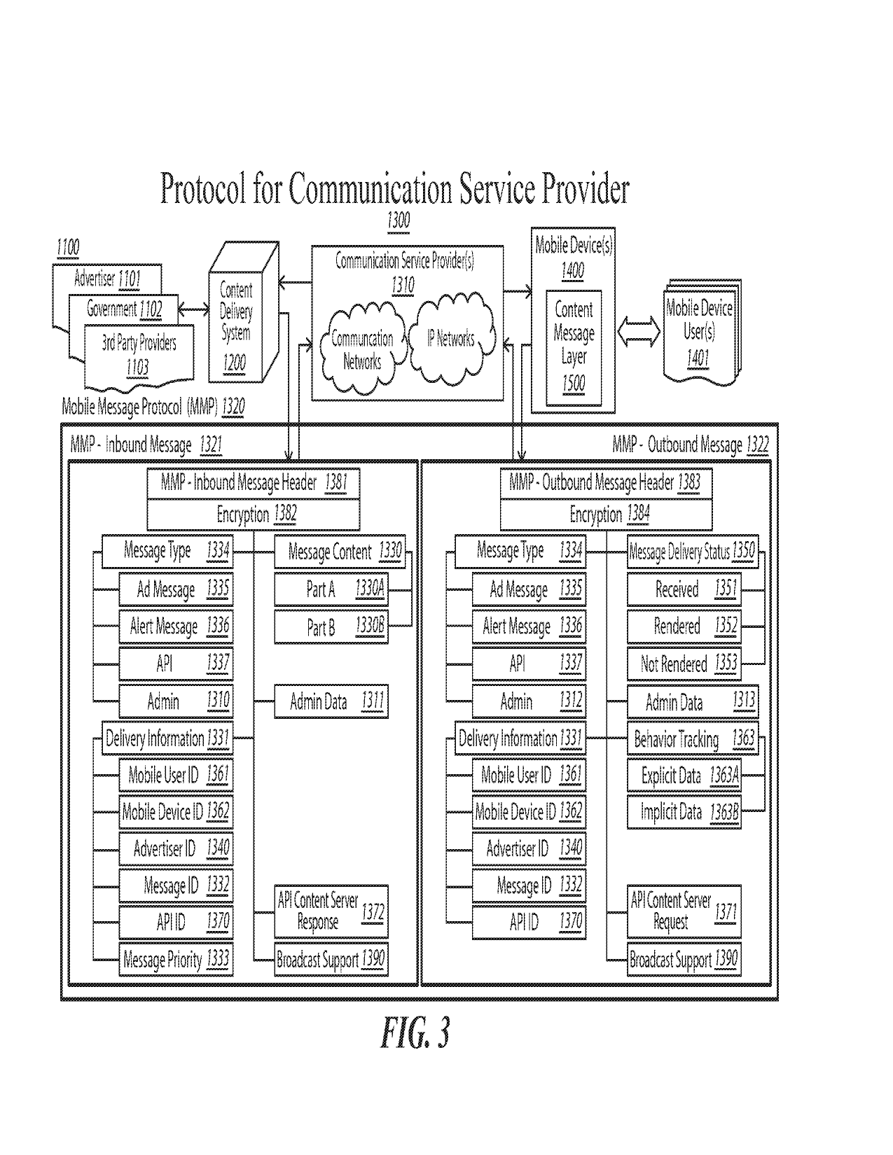

Protocol for Communication Service Provider (PCSP) 1300—Referring to FIG. 3, this figure illustrates the embodiment of the PCSP 1300. The PCSP 1300 is a formatted data package to transport messages to and from mobile devices 1400 using existing communication service provider's network and protocols; and it serves to optimize the CDS 1200 and CML 1500 communication relationship. A communications service provider 1310 is a service provider that transports information electronically. The term encompasses public and private companies in the telecom (landline and wireless), Internet, cable, satellite, and managed services businesses. A communications protocol is a system of digital message formats and rules for exchanging those messages in or between computing systems and in telecommunications. The PCSP 1300 consists of Mobile Message Protocol (MMP) 1320 with two digital message formats: the first for MMP inbound messages 1321 and the second for MMP outbound messages 1322. This embodiment illustrates the digital message formats used to transmit messages to and from the CDS 1200 and the CML 1500 on the mobile device 1400. MMP inbound messages 1321 are transmitted to the CML 1500 and MMP outbound messages 1322 are transmitted from the CML 1500.

MMP 1320 represents a specialized top application layer, Layer 7 of the OSI Telecommunication Stack. Open Systems Interconnection (OSI) model is a product of the Open Systems Interconnection effort at the International Organization for Standardization. It is a prescription of characterizing and standardizing the functions of a communications system in terms of abstraction layers. Similar communication functions are grouped into logical layers. A layer serves the layer above it and is served by the layer below it. The top application layer in the OSI model facilitates interaction between familiar entities. The MMP 1320 protocol is a specialized top application layer that facilitates interaction between the CDS 1200 and the CML 1500 on the mobile device 1400.

In this embodiment, the in and out bound message formats (1321 and 1322) are illustrated in detail and are further illustrated in context to the interaction between the CDS 1200 and the CML 1500 on the mobile device 1400.

The MMP inbound message 1321 traverses from the CDS 1200 through the communication service providers 1310 to the CML 1500 on the mobile device 1400. In this embodiment, the MMP inbound message 1321 format is composed of six major components: the MMP inbound message header 1381, message type 1334, delivery information 1331, message content 1330, administration data 1311, and API content server response 1372. The message header 1381 refers to supplemental data placed at the beginning of a block of data being stored or transmitted. The encryption 1382 is illustrated as a subcomponent to the MMP inbound message header 1381 and it refers to the security protocol of the MMP inbound message 1321. The message type 1334 illustrates the four types of messages transmitted from the CDS 1200 to the mobile device 1400 for CML 1500 processing. The four message types are: ad message 1335, alert messages 1336, API messages 1337, and administrative messages 1310. The delivery information 1331 illustrates the five unique identifiers directly linked to each message type 1334 transmitted from the CDS 1200 to the mobile device 1400 for CML 1500 processing; plus a delivery priority flag that is used to alert messages 1336 for further processing. The five delivery information 1331 identifiers are: mobile device user (1401) ID 1361, mobile device (1400) ID 1362, advertiser (1100) ID 1340, message ID 1332, and API ID 1370; and the delivery priority flag is message priority 1333. The message content 1330 illustrates two parts of the ad message and alert message transmitted from the CDS 1200 to the mobile device 1400 for CML 1500 processing. The two parts of the message content are the same two parts of the message template: Part A 1330A and Part B 1330B. The administration data 1311 illustrates the various administrative elements transmitted from the CDS 1200 to the mobile device 1400 for CML 1500 processing; to include but not limited to: Part C data, user profile cookie data, digital resource center data, software and system updates. The API content server response 1372 illustrates the various API related data responses transmitted from the CDS 1200 to the mobile device 1400 for CML 1500 processing. The broadcast support 1390 illustrates utilizing a given radio layer protocol for broadcast capabilities to facilitate updates to the CML 1500.

The MMP outbound message 1322 traverses from the CML 1500 on the mobile device 1400 through the communication service providers 1310 to the CDS 1200. In this embodiment, the MMP outbound message 1322 format is composed of seven major components: the MMP outbound message header 1383, message type 1334, delivery information 1331, message delivery status 1350, administration data 1313, behavior tracking data 1363, and API content server request 1371. The message header 1383 refers to supplemental data placed at the beginning of a block of data being stored or transmitted. The encryption 1384 is illustrated as a subcomponent to the MMP outbound message header 1383 and it refers to the security protocol of the MMP outbound message 1322. The message type 1334 illustrates the four types of messages transmitted from CML 1500 on the mobile device 1400 to the CDS 1200 for processing. The four message types are: ad message 1335, alert messages 1336, API messages 1337, and administrative messages 1312. The delivery information 1331 illustrates the five unique identifiers directly linked to each message type 1334 transmitted from CML 1500 on the mobile device 1400 to the CDS 1200 for processing. The five delivery information 1331 identifiers are: mobile device user (1401) ID 1361, mobile device (1400) ID 1362, advertiser (1100) ID 1340, message ID 1332, and API ID 1370. The message delivery status 1350 illustrates the three delivery confirmation statuses of whether both parts (1330A and 1330B) of the message content 1330 were received 1351 by the CML 1500 and whether the message content 1330 was rendered 1352 or not rendered 1353; this message delivery status 1350 is subsequently transmitted from CML 1500 on the mobile device 1400 to the CDS 1200 for processing. The administration data 1313 illustrates the various administrative elements transmitted from the CML 1500 on the mobile device 1400 to the CDS 1200 for processing. The behavior tracking 1363 illustrates the two types of the mobile device user's 1401 behavior information captured, tracked and transmitted from the CML 1500 on the mobile device 1400 to the CDS 1200 for processing. The two types of behavior tracking information are: explicit 1363A and implicit 1363B data. The API content server request 1371 illustrates the various API related requests for content server information transmitted from the CML 1500 on the mobile device 1400 to the CDS 1200 for processing. The broadcast support 1390 illustrates utilizing a given radio layer protocol for broadcast capabilities to facilitate updates to the CML 1500.

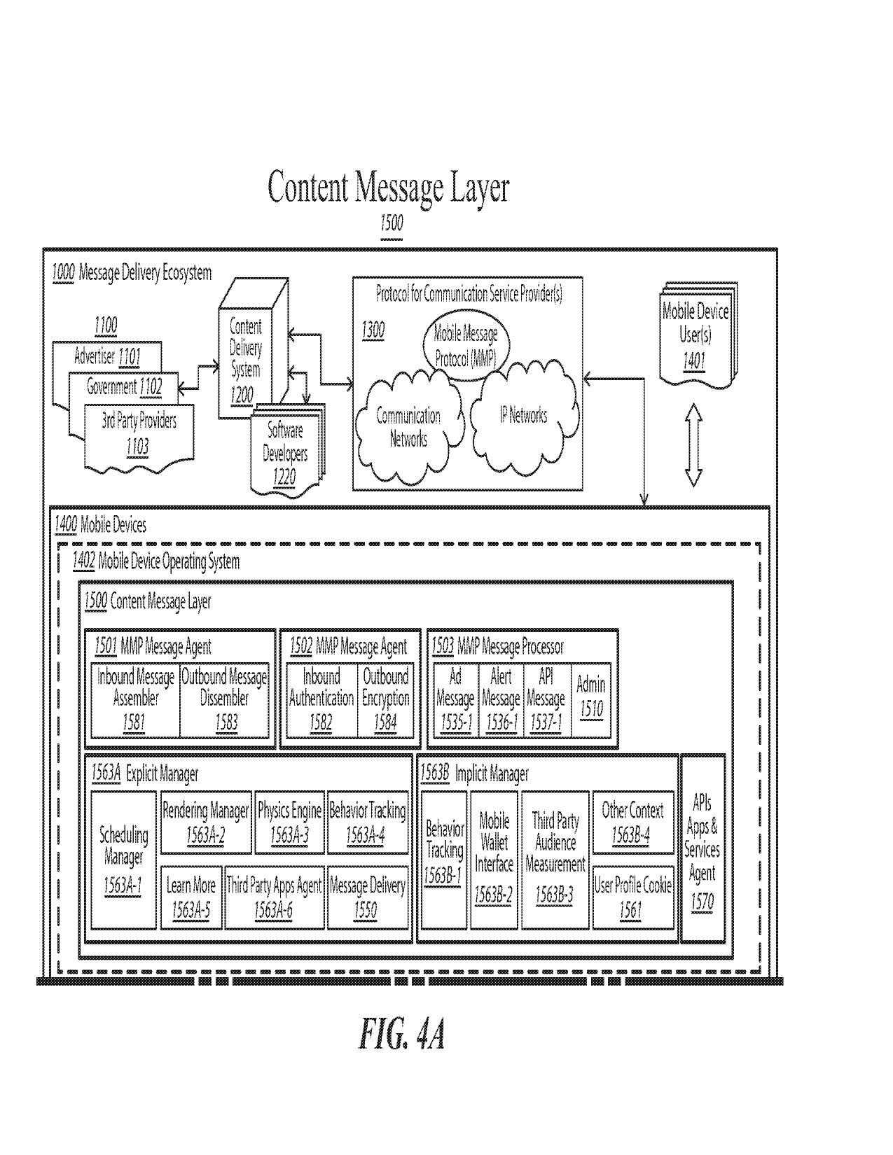

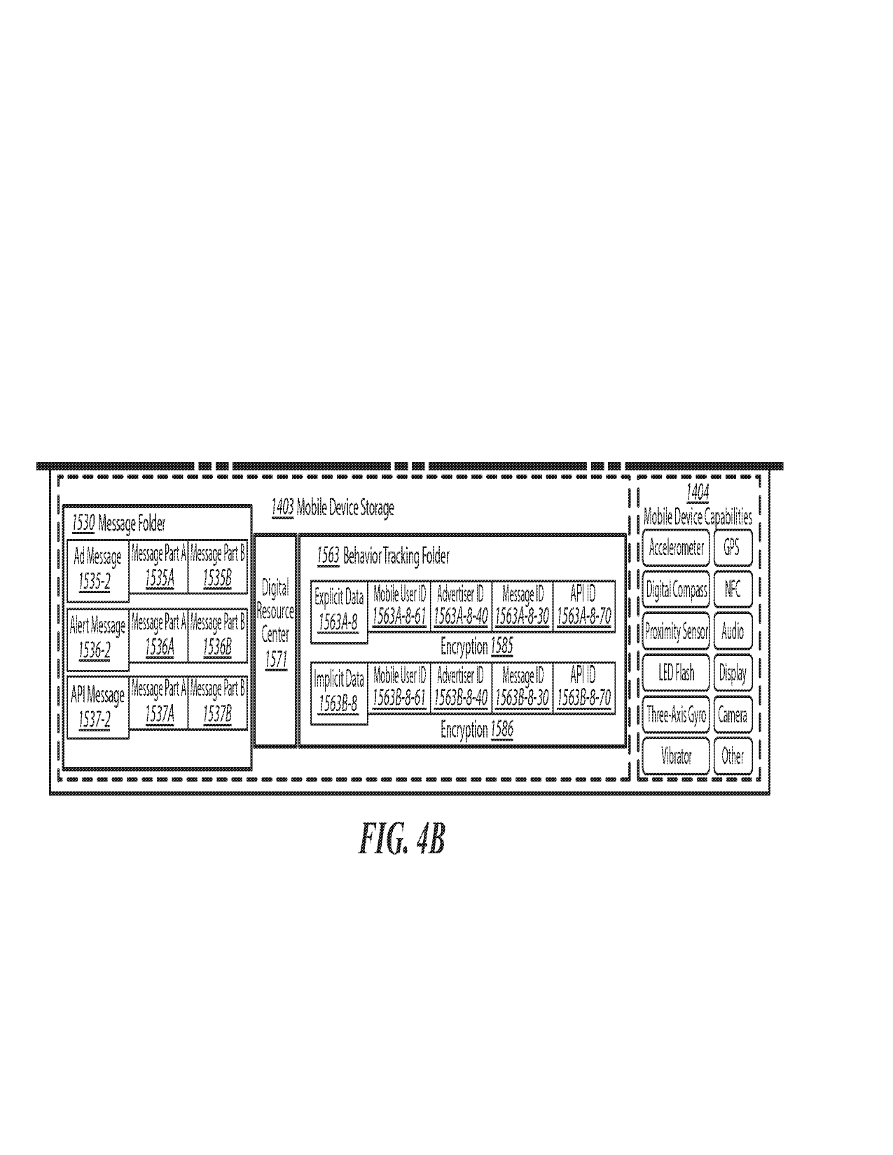

Content Message Layer (CML) 1500—Referring to FIG. 4, this figure illustrates the embodiment of the CML 1500. The CML 1500 is an apparatus within the operating system 1402 of the mobile device 1400. The CML 1500 is a stored executable code that interfaces and manipulates the mobile device operating system 1402, the mobile device storage 1403, and the mobile device capabilities 1404 to receive, store and render messages sent by the CDS 1200 via the PCSP 1300; to capture, store, and transmit the mobile device user's 1401 direct and indirect responses to the messages back to the CDS 1200 via the PCSP 1300; and to execute a set of APIs to request and obtain addressable mobile device user's 1401 profile information and selected ad messages from the CDS 1200 via the PCSP 1300 and have the requested profile information and ad messages sent back to the CML 1500 via the PCSP 1300. Additionally, the mobile device user 1401 is able to affect changes to their profile information in the CDS 1200 that influences attributes in the CML 1500 that in turn influences the kind, nature and frequency of messages addressed to them from the CDS 1200. The CML's 1500 stored executable code uses the mobile device's 1400 capabilities to execute its functionality. In this embodiment the CML's 1500 functional components consist of the MMP message agent 1501, MMP security agent 1502, MMP message processor 1503, explicit manager 1563A, implicit manager 1563B, and the APIs applications and services agent 1570.

The CML 1500 has at least five preferred embodiments detailed herein: 1) the software developer's 1220 view; 2) the advertiser's 1100 view (all advertisers 1101; the government 1102, and third-party providers 1103); 3) the government's 1102 view; 4) the view from using APIs; and 5) the mobile device user's 1401 view. These views are presented to illustrate the different embodiments of the CML 1500 and how the various functional components are deployed on the mobile device 1400 and how they interface with the PCSP 1300 and the CDS 1200.

Content Message Layer 1500 (Software Developer's 1220 View)—Sub-elements of FIG. 4 illustrate the view point from the software developer 1220. In this embodiment, the message template as created by the software developer 1220 and as acquired by the advertiser 1100 is transmitted from the CDS 1200 using the PCSP 1300 to the CML 1500 on the mobile device 1400 for processing.

The initial steps of the process include: the inbound message assembler 1581 within the MMP message agent 1501 to assemble the received transmission; the inbound authentication 1582 within the MMP security agent 1502 applies data and identity security policies; and then depending on the type of message received, the MMP message processor 1503 using the ad message 1535-1, the alert message 1536-1, the API 1537-1 elements, first stores the message in the message folder 1530, as part of the mobile device storage 1403, in their respective folders, ad message 1535-2, alert message 1536-2, and API 1537-2, and then passes the advertiser 1100 defined delivery sub-elements of the message for the ad message 1535-1 and alert message 1536-1 to the scheduling manager 1563A-1 for further processing.

The transmitted ad message and alert message consists of two parts and can be transmitted together or separately; when both parts have been stored in the respective message folder (1535-2, 1536-2, or 1537-2) and paired by the respective MMP message processor (1535-1, 1536-1, or 1537-1) into the respective message Part A (1535A, 1536A, or 1537A) and respective message Part B (1535B, 1536B, or 1537B) storage, the respective MMP message processor (1535-1, 1536-1, or 1537-1) executes the message delivery 1550 sub-element of the explicit manager 1563A and a message delivery confirmation is created. Subsequently, the respective MMP message processor (1535-1, 1536-1, or 1537-1) processes the outbound message delivery 1550 status to the MAP security agent 1502 for outbound encryption 1584, and then to the MAP message agent 1501 for outbound dissembler 1583 for transmission to the CDS 1200 using the PCSP 1300.

Next, based on the advertiser's 1100 defined event(s), the scheduling manager 1563A-1 will queue the ad message for immediate rendering on the mobile device 1400.

When creating the message template in the CDS 1200, the software developer 1220 selects elements of the mobile device's capabilities 1404 to create a message template for rendering purposes. Based on what the software developer 1220 has created, there are numerous embodiments of what a message template could render on a mobile device 1400, with and without input from the mobile device user 1401. Once the scheduling manager 1563A-1 queues the message template for immediate rendering and after a first triggering event occurs, the rendering manager 1563A-2 actuates the message template rendering instructions, as created by the software developer 1220, and executes the functionality of mobile device capabilities 1404 and the pre-stored elements of Part C in the Digital Resource Center (DRC) 1571 and/or the physics engine 1563A-3 (see paragraph [0089]); for message template rendering. There are two primary illustrations of the message template rendering: without input or interaction from the mobile device user 1401 and with input or interaction from the mobile device user 1401. In the former illustration, there are numerous embodiments and the rendering starts immediately after a first triggering event occurs and continues rendering until a second trigger event occurs or until the display times out or the mobile device 1400 is unlocked. In the latter illustration, there are also numerous embodiments and the rendering, after it is started, can be altered, changed, or otherwise impacted by input or interaction from the mobile device user 1401. One example of the latter illustration is:

Immediately after the first triggering event—a character of a woman appears, dressed in a fashionable business suit from a local department store. The woman stands with one hand on her hip and the other extended outwardly with her palm up. The local department store's logo is in the bottom left corner and after the first two seconds the image of the woman slowly rotates clockwise, while at the same time, little square pieces of paper fall from the top of the screen with different lettering written on them—some say 5% off, some 10% off and others say 15% off. The little squares fall over the woman and eventually to the ground, but one lands on the woman's outwardly extended hand—it reads 10% off. All of this takes five seconds. The mobile device user 1401 could blow air into the mobile device's 1400 microphone and cause all of the pieces of paper on the ground and in the woman's hand to blow upwardly to the top of the screen. If the mobile device user 1401 continues to blow, all the papers will also continue to blow upwardly and swirl at the top of the screen. When mobile device user 1401 stops blowing, the paper will re-float back down again, and based on randomness, the same or a different discount percent amount could land in the woman's hand. This could be repeated until the 15% off paper lands in the hand.

In this example, the software developer 1220 created a message template that utilized the physics engine 1563A-3 and elements of the mobile device capabilities 1404 for rendering purposes. The little pieces of paper floating down from the top of the screen depicted the gravity properties of the physics engine 1563A-3; and the microphone (listed as other) as an element of the mobile device capabilities 1404 captured the blowing sound from the mobile device user 1401 to change and alter what was being rendered and to actuate the little pieces of paper being blown upward into the air off the ground.

Once rendered, regardless of the rendering duration, the scheduling manager 1563A-1 executes the message delivery 1550 and a message rendered delivery confirmation is created. Subsequently, the MMP respective message processor (1535-1, 1536-1, or 1537-1) processes the outbound message delivery 1550 status to the MMP security agent 1502 for outbound encryption 1584, then to the MMP message agent 1501 for outbound dissembler 1583 for transmission to the CDS 1200 using the PCSP 1300.

Collectively, this embodiment illustrates the method for rendering messages for the at least five preferred views herein.

Content Message Layer 1500 (Advertiser's 1100 View)—Sub-elements of FIG. 4 illustrate the view point from the advertiser 1100—all advertisers 1101, government 1102, and third-party providers 1103. In this embodiment, in CDS 1200, the advertisers 1100 define the delivery elements of time block and location of when and where their messages are rendered; in the CML 1500, these defined delivery elements are sub-elements of the ad message Part B 1535B; which upon receipt, the ad message 1535-1 of the MMP message processor 1503 passes these delivery elements to the scheduling manager 1563A-1 for processing. The scheduling manager 1563A-1 uses the clock, calendar, global positioning system (GPS), frequency radio, Wi-Fi, and other elements of the mobile device capabilities 1404 to create a queue of sequenced ad messages scheduled for immediate rendering based the delivery elements.

In this embodiment, the time block delivery element is a representation of time as determined by the clock and calendar components of the mobile device capabilities 1404. Time is illustrated by a block of time that when all the time blocks are added together they represent a single twenty-four hour day; a single day is a subset of the calendar. In the CDS 1200, the advertiser 1100 defines the day(s) and time block(s) for when the ad message is scheduled for rendering; additionally, in the CDS 1200 the advertiser 1100 can also define rollover block(s) of time, rollover is a method to keep the ad message in the scheduling manager 1563A-1 queue for multiple time blocks across multiple days; this rollover method enables the scheduling manager 1563A-1 to retain the ad message in the queue long enough to be rendered by a first triggering event, or until the blocks of time expire, after which the ad message is removed from the queue.

Once any ad message is not rendered and has been removed from the queue, the scheduling manager 1563A-1 executes the message delivery 1550 and a message not rendered delivery confirmation is created. Subsequently, the ad message 1535-1 of the MMP message processor 1503 processes the outbound message delivery 1550 status to the MMP security agent 1502 for outbound encryption 1584, then to the MMP message agent 1501 for outbound dissembler 1583 for transmission to the CDS 1200 using the PCSP 1300 for further processing.

In this embodiment, the location delivery element is a representation of geographical location as determined by the GPS, frequency radio, Wi-Fi, and/or other components of the mobile device capabilities 1404. GPS refers to a space-based satellite navigation system that provides location anywhere on the earth, including terrestrial repeaters or augmentation signals to the space-based satellite system. Frequency radio refers to the attaining of the current position of a mobile device 1400, stationary or moving via multilateration of radio signals between (several) radio towers of the cellular network and the mobile device 1400. Wi-Fi refers to technology that allows the mobile device 1400 to exchange data wirelessly (using radio waves) over a computer network, including high-speed Internet connections. In the CDS 1200, the advertiser 1100 defines the location and/or representation for where the mobile device 1400 should be geographically for when the ad message is scheduled to be rendered.

Whenever a first triggering event occurs, the scheduling manager 1563A-1 deploys the rendering manager 1563A-2 to immediately render the first ad message in the queue. See paragraphs [0144] to [0147] for the method to render an ad message. After the first triggering event the scheduling manager 1563A-1 advances the next scheduled ad message for immediate rendering. If there is no second triggering event and the mobile device 1400 is unlocked, the scheduling manager 1563A-1 holds in the queue the next scheduled ad message for the next first triggering event. Any time after there is no second triggering event and the mobile device 1400 was unlocked and a new first triggering event occurs, the scheduling manager 1563A-1 deploys the rendering manager 1563A-2 to immediately render the next ad message in the queue. This reiterative queuing and rendering by the scheduling manager 1563A-1 continues dynamically, within and across time blocks and geographical locations. When time and location based ad messages are exhausted in the queue, within a time block and/or location, the scheduling manager 1563A-1 begins queuing for rendering ad messages that do not have defined delivery elements, those from third-party providers 1103 (see paragraph [0122]).

Whenever a second triggering event occurs, the rendering manager 1563A-2 immediately transitions to the learn more 1563A-5 attributes; the first such attribute is the companion page of the ad message. The companion page is also referred to as the offer page; where the advertiser 1100 presents the essence of the ad message; its definition is crafted by the advertiser 1100 in the CDS 1200, see paragraph [0099]. After the learn more 1563A-5 presents the companion page, the mobile device user 1401 either navigates away or he/she navigates to the remaining learn more 1563A-5 attributes presented. These remaining attributes are also defined by the advertiser 1100 and are comprised of web links and other means to convey information, which, when tailored to a specific ad message, provides additional information to the mobile device user 1401 about the subject and essence of the ad message, the product, service or brand. All attributes are consistently organized regardless of the product, service, or brand category and are also standardized in how the mobile device user 1401 navigates to each. Additionally, each attribute provides trackable elements that are captured and stored.

The behavior tracking 1563A-4 captures the trackable elements of the mobile device user 1401 interaction with the learn more 1563A-5 attributes; and each captured element is stored in the behavior tracking folder 1563 in the explicit data 1563A-8. Each captured element may additionally contain a mobile device user(s) 1401 identifier, which is stored in mobile user ID 1563A-8-61; an advertiser(s) 1100 identifier, which is stored in advertiser ID 1563A-8-40, and a message identifier, which is stored in message ID 1563A-8-30. Periodically, the behavior tracking 1563A-4 deploys the ad message 1535-1 of the MMP message processor 1503 to outbound transmit the explicit data 1563A-8 to CDS 1200 for further processing (see paragraphs [0102] to [0106]), via the MMP security agent 1502 and the MMP message agent 1501.

Collectively, these embodiments illustrate methods for how, when and where ad messages are rendered and how the mobile device user's 1401 message responses are captured, stored and transmitted to the CDS 1200 for further processing.

Content Message Layer 1500 (Government's 1102 View)—Sub-elements of FIG. 4 illustrate the view point from the government 1102 (foreign or domestic national, state, county, and local government entities (and their foreign equivalents), and wireless carriers). This view has two embodiments: as a regular advertiser 1100 and as a government 1102 entity. As the former, a regular advertiser 1100, they may deploy the same systems, methods and apparatus as discussed in paragraphs [0149] to [0156] above. The latter embodiment addresses the government's 1102 role as part of the Emergency Alert System and/or other alert messaging requirements.

In the CDS 1200, four distinct methods unique to the government 1102 were illustrated: first, alert messages used only by the government 1102; second, the ability to prioritize the message delivery to supersede all other messages; third, the ability to render the message without a first triggering event; and fourth, a specialized API interface with the CML 1500 for establishing two-way communication. In this embodiment, these same corresponding four distinct aspects of the government 1102 are illustrated in the CML 1500 apparatus.

In this embodiment, Part A of the message template of the alert messages has been preinstalled (stored) in the message Part A 1536A of the alert message 1536-2 folder in the message folder 1530; or later created or modified in the CDS 1200, subsequently transmitted through the PCSP 1300, processed by the MMP message agent 1501, MMP security agent 1502, the alert message 1536-1 of the MMP message processor 1503, and then consequently stored in the message Part A 1536A of the alert message 1536-2 folder in the message folder 1530. Part B of the alert message is created in the CDS 1200 or through an interface with the Common Alert Protocol (CAP) and is subsequently transmitted through the PCSP 1300, processed by the MMP message agent 1501, MMP security agent 1502, the alert message 1536-1 of the MMP message processor 1503, and then consequently stored in the message Part B 1536B of the alert message 1536-2 folder in the message folder 1530. When both parts have been stored in the message folder 1530 and paired by the alert message 1536-1 into the message Part A 1536A and message Part B 1536B storage, the alert message 1536-1 executes the message delivery 1550 sub-element of the explicit manager 1563A and a message delivery confirmation is created. Subsequently, the alert message 1536-1 processes the outbound message delivery 1550 status to the MMP security agent 1502 for outbound encryption 1584, and then to the MMP message agent 1501 for outbound dissembler 1583 for transmission to the CDS 1200 using the PCSP 1300.

In this embodiment, when the alert message 1536-1 receives and processes for storage the alert message Part B 1536B, this transmission may also contain a message priority element defined by the government 1102; when received, the alert message 1536-1 passes the message priority element to the scheduling manager 1563A-1 for further processing. This message priority element may be defined by the government 1102 to supersede all other messages in the scheduling manager 1563A-1 queue. The scheduling manager 1563A-1 consequently sequences the alert message in the message delivery queue based on this prioritization.

In this embodiment, the message priority element defined by the government 1102 may be defined to render the alert message without a first triggering event. In this illustration, without waiting on a first triggering event, the scheduling manager 1563A-1 either renders the alert message immediately or renders it based on the government 1102 defined delivery elements that are sub-elements of the alert message Part B 1536B.

In this embodiment, specialized APIs Applications and Services Agent (AASA) 1570 enable the government 1102 to establish two-way communication between the mobile device 1400 and the government 1102; in this illustration, the AASA 1570 interfaces with the mobile device capabilities 1404 to establish two-way communication.

Content Message Layer 1500 (View Using APIs)—Sub-elements of FIG. 4 illustrate the view using APIs. There are multiple embodiments to the AASA 1570, but only two are illustrated herein: third-party applications installed on the mobile device 1400 requesting ad messages from the CDS 1200 to be sent to the mobile device 1400 for independent rendering by third-party applications; and third-party applications installed on the mobile device 1400 requesting consumer segmentation or consumer analytics data from the CDS 1200 to be sent to the mobile device 1400 for consumption by the third-party application.

Third-party applications installed on the mobile device 1400 requesting ad messages from the CDS 1200 to be sent to the mobile device 1400 for independent rendering by third-party applications is illustrated in this embodiment. Each third-party application that utilizes the AASA 1570 has a unique identifier, the API identifier. Through an authentication process, the third-party application accesses the AASA 1570 to request a specific ad message to be sent from the CDS 1200; this API content server request is processed by the AASA 1570, through to the API message 1537-1 of the MMP message processor 1503, the MMP security agent 1502, the MMP message agent 1501, and then through the PCSP 1300 to the CDS 1200 for processing. Subsequently, the CDS 1200 sends the API message content (Part A and B) back through the PCSP 1300 through to the MMP message agent 1501, the MMP security agent 1502, the API message 1537-1, and then the API message 1537-2 for storage and to the third-party application agent 1563A-6 for processing. When both parts have been stored in the message folder 1530 and paired by the API message 1537-1 into the API message 1537-2, message Part A 1537A and message Part B 1537B storage, the API message 1537-1 executes the message delivery 1550 sub-element of the explicit manager 1563A and a message delivery confirmation is created. Subsequently, the API message 1537-1 processes the outbound message delivery 1550 status to the MMP security agent 1502 for outbound encryption 1584, and then to the MMP message agent 1501 for outbound dissembler 1583 for transmission to the CDS 1200 using the PCSP 1300.

Different than all other advertiser's 1100 ad messages, the API initiated ad messages are not processed nor sequenced for rendering by the scheduling manager 1563A-1. The third-party application, using the third-party application agent 1563A-6, controls the method of when and where the API initiated ad messages are rendered. The third-party application agent 1563A-6 supplants the first triggering event for initiating the rendering process with a third-party application created event. Once the third-party application agent 1563A-6 initiates the API initiated ad message to render, the rendering manager 1563A-2 actuates the API initiated ad message rendering instructions, as created by the software developer 1220, and executes the functionality of mobile device capabilities 1404 and the pre-stored elements of Part C in the Digital Resource Center (DRC) 1571 and/or the physics engine 1563A-3 (see paragraph [0089]) for message template rendering. There are two primary illustrations of the API initiated ad message rendering: without input or interaction from the mobile device user 1401 and with input or interaction from the mobile device user 1401. In the former illustration, there are numerous embodiments and the rendering starts immediately when the third-party application agent 1563A-6 initiates the API initiated ad message to render and continues rendering until a second trigger event occurs or until the display times out. In the latter illustration, there are also numerous embodiments and the rendering, after it is started, can be altered, changed, or otherwise impacted by input or interaction from the mobile device user 1401.

Whenever a second triggering event occurs, the rendering manager 1563A-2 immediately transitions to the learn more 1563A-5 attributes; the first such attribute is the companion page of the API initiated ad message. After the learn more 1563A-5 presents the companion page, the mobile device user 1401 either navigates away or he/she navigates to the remaining learn more 1563A-5 attributes presented; each attribute provides trackable elements that are captured and stored.

The behavior tracking 1563A-4 captures the trackable elements of the mobile device user 1401 interaction with the learn more 1563A-5 attributes; and each captured element is stored in the behavior tracking folder 1563 in the explicit data 1563A-8. Each captured element contains the API identifier, which is stored in API ID 1563A-8-70; and may additionally contain a mobile device user(s) 1401 identifier, which is stored in mobile user ID 1563A-8-61; an advertiser(s) 1100 identifier, which is stored in advertiser ID 1563A-8-40, and a message identifier, which is stored in message ID 1563A-8-30. Periodically, the behavior tracking 1563A-4 deploys the API message 1537-1 to outbound transmit the explicit data 1563A-8 to CDS 1200 for further processing, via the MMP security agent 1502 and the MMP message agent 1501.

Third-party applications installed on the mobile device 1400 requesting consumer segmentation or consumer analytics data from the CDS 1200 to be sent to the mobile device 1400 for consumption by the third-party application is illustrated in this embodiment. Through an authentication process, the third-party application accesses the AASA 1570 to request consumer segmentation or consumer analytics data to be sent from the CDS 1200; this API content server request is processed by the AASA 1570, through to the API message 1537-1, the MMP security agent 1502, the MMP message agent 1501, and then through the PCSP 1300 to the CDS 1200 for processing. Subsequently, the CDS 1200 sends an API content server response back through the PCSP 1300 through to the MMP message agent 1501, the MMP security agent 1502, the API message 1537-1, and then the DRC 1571 for storage and to the third-party application agent 1563A-6 for processing.

There are numerous embodiments of what third-party applications can do with the consumer segmentation or consumer analytics data received from CDS 1200 and stored in the DRC 1571. This consumer segmentation or consumer analytics data include one or more trackable elements of the mobile device user's 1401 interaction with the consumer segmentation or consumer analytics data; each captured element is stored in the behavior tracking folder 1563 in the explicit data 1563A-8. Each captured element contains the API identifier, which is stored in API ID 1563A-8-70; and may additionally contain a mobile device user(s) 1401 identifier, which is stored in mobile user ID 1563A-8-61; an advertiser(s) 1100 identifier, which is stored in advertiser ID 1563A-8-40, and a message identifier, which is stored in message ID 1563A-8-30. Periodically, the behavior tracking 1563A-4 deploys the MMP message processor 1503 to outbound transmit the explicit data 1563A-8 to CDS 1200 for further processing, via the MMP security agent 1502 and the MMP message agent 1501.

Content Message Layer (Mobile Device User 1401 View)—Sub-elements of FIG. 4 illustrate the mobile device user 1401. In this embodiment, rendered messages from advertisers 1100 are accessible to the mobile device user 1401; and the subsequent direct and indirect mobile device user's 1401 exposure and interaction with messages initiated by the advertiser 1100 are captured, stored and transmitted.

In this embodiment, many modern mobile devices 1400 deploy a logical or physical locking mechanism to prevent accidental or unintended use of the device; once unlocked the mobile device user 1401 gains full access to the mobile device 1400; while the device is locked, the mobile device user 1401 has limited access. The term “lock-screen display” refers to the screen display seen upon waking up a mobile device 1400 from sleep mode by engaging a logical or physical input key. The lock-screen display is only seen during the period between wake-up of the mobile device 1400 and unlocking of the mobile device 1400. The lock-screen display has both an active state and a passive state; in the active state, the mobile device 1400 is turned on and the display is actively engaged; and in the passive state, the mobile device 1400 is turned on but it is asleep and nothing is displayed. In the former, the lock-screen display can convey a large variety of things, from internal to the mobile device 1400 driven events like alarm clocks, calendar alerts, and status of what music is being played, to external to the mobile device 1400 driven events like email notifications, incoming phone calls, and stock alerts. The commonality across all active state events is that each event wakes the mobile device 1400 from the sleep mode and actively engages the lock-screen display. In the latter, the lock-screen display is absent of any active engagement and the mobile device 1400 is asleep, and the mobile device 1400 continues in this sleep or passive state until a triggering event occurs to wake it from sleep or the battery dies. A triggering event to wake the mobile device 1400 from sleep mode can be a logical or physical input, and after the triggering event, many modern mobile devices 1400 will display a lock-screen wallpaper, a clock, or another representation of being temporarily awake and active on the lock-screen display. This temporary wake state persists until either the mobile device user 1401 deploys a logical or physical unlocking mechanism or the lock-screen display times-out and the mobile device 1400 goes back to sleep.

In this illustration, the triggering event that causes the mobile device 1400 to wake temporarily from the sleep mode is herein referred to as the “first triggering event”. In the place of a lock-screen wallpaper, a clock, or another representation of being temporarily awake, the rendering manager 1563A-2 will render the next scheduled advertiser's 1100 message. The advertiser's 1100 message will persist rendering until the lock-screen display times-out, the mobile device user 1401 deploys a logical or physical unlocking mechanism, or mobile device user 1401 deploys a logical or physical second triggering event. In this embodiment, the second triggering event is a representation of the mobile device user 1401 going to the next step in the advertiser's 1100 message and/or rendering process.

Between the first and second triggering events, the mobile device user 1401 engages, interacts, or otherwise plays with the advertiser's 1100 message using the mobile device capabilities 1404. There are numerous embodiments of this interaction, and the following is one example:

The instant following the first triggering event—animated mercury balls quickly roll and collide with each other onto the lock-screen display from all directions; simultaneously the mobile device 1400 correspondingly vibrates and makes a rumbling sound; with each collision a sucking sound is heard as the balls congeal together; eventually (three seconds later) the congealed mercury forms an accurate representation of a name brand pickup truck, and then to a quiet background, where a gruff voice says ‘Pickup Truck Tough’. The mobile device user 1401 could shake the mobile device 1400 and the mercury balls will scatter off the lock-screen display, then the sequence would start all over again. The mobile device user 1401 could further delay the unlocking process and after five seconds the screen would go black and the sequence would start over again, but with every iteration, the action would slow down by 25%, and after the fifth iteration it would freeze with the representation of the pickup truck staying on the screen. If the mobile device user 1401 was interested in learning more about the name brand pickup truck, the mobile device user 1401 could long-touch the lock-screen display (an illustration of a second triggering event), when doing so the lock-screen display would react as if a finger was inserted into water and ripples would start from the mobile device user's 1401 touch point and ripple out to the lock-screen display's edges; when the mobile device user 1401 lifts his or her finger from the long-touch, the water and pickup truck would explode off the screen accompanied by a corresponding sound and vibration, and then the screen would go black. At anytime—beginning, middle or end—of the ad rendering process, the mobile device user 1401, without delay, can unlock his or her mobile device 1400 by moving the logical or physical input.

In this illustrated embodiment, the government 1102 defines a message priority causing the scheduling manager 1563A-1 to render an alert message without a first triggering event. There are many illustrations of this embodiment and the following represents two: while the mobile device 1400 is in the sleep and locked state, and while the mobile device 1400 is in the active and unlocked state.

The first illustrative embodiment is while the mobile device 1400 is in the sleep and locked state. In the CDS 1200 or through an interface with the Common Alert Protocol, the government 1102 defines a message priority delivery to supersede all other messages in the scheduling manager 1563A-1 queue and to render while the mobile device 1400 is in the sleep and locked state. Based on delivery elements and message priority of the received and processed alert message, if the mobile device 1400 is asleep and locked, the rendering manager 1563A-2 engages the necessary mobile device capabilities 1404 to wake the mobile device 1400 from the sleep state, and then renders the alert message. Based on delivery elements and message priority of the received and processed alert message, if the mobile device 1400 is unlocked and in an active state, the rendering manager 1563A-2 waits for the mobile device 1400 to return to a sleep and locked state, and then the rendering manager 1563A-2 engages the necessary mobile device capabilities 1404 to wake the mobile device 1400 from the sleep state to render the alert message.

The second illustrative embodiment is while the mobile device 1400 is active and unlocked. In the CDS 1200 or through an interface with the Common Alert Protocol, the government 1102 defines a message priority delivery to supersede all other messages in the scheduling manager 1563A-1 queue and to render while the mobile device 1400 is active and in an unlocked state. Based on delivery elements and message priority of the received and processed alert message, the rendering manager 1563A-2 engages the mobile device capabilities 1404 to interrupt the necessary mobile device 1400 activities and then renders the alert message.

Third-party applications acquired independently by the mobile device user 1401, through means outside the MDE 1000 that are used on their mobile device 1400, which contain specific APIs that interface with the CDS 1200 or the AASA 1570 are illustrated in this embodiment. These APIs provide a method for third-party application developers to leverage the information entered, captured and tracked about the mobile device user 1401, and to create innovative commerce, social, or other focused applications. There are numerous embodiments of how third-party application developers could use mobile device user's 1401 profile information to create games, services, product demonstrations, social interaction, user generated content, contextual search, user lifestyle enablers, and other unnamed applications. Common to each embodiment is the API identifier and the use of the mobile device user's 1401 profile information to innovate to provide a service, utility, entertainment or value to the mobile device user 1401.

In this embodiment, capturing, storing and transmitting the mobile device user's 1401 explicit behavior is illustrated. Explicit behavior is information derived directly from the mobile device user's 1401 exposure and interaction with messages initiated by the advertiser 1100. The behavior tracking 1563A-4 captures every exposure and interaction the mobile device user 1401 has with each message, excluding message delivery 1550 items (see paragraph [0147]). All captured explicit behavior is stored and encrypted (1585) in the explicit data 1563A-8 in the behavior tracking folder 1563. Periodically, the behavior tracking 1563A-4 deploys the respective message (ad message 1535-1, alert message 1536-1, or API message 1537-1) processor of the MMP message processor 1503 to outbound transmit the explicit data 1563A-8 to CDS 1200 for further processing, via the MMP security agent 1502 and the MMP message agent 1501.

There are numerous embodiments of this illustration, the common method among them is a message identifier that is captured and stored in the message ID 1563A-8-30; with each mobile device user's 1401 exposure and interaction to each message (rendering and learn more 1563A-5 attributes), the behavior tracking 1563A-4 captures and stores the associated message identifier along with the trackable elements of the exposure and interaction into their respective folders, message ID 1563A-8-30 and explicit data 1563A-8. In this embodiment, from a mobile device user's 1401 prospective, the message has two elements: rendering and the learn more 1563A-5 attributes.

Rendering—immediately following a first triggering event and simultaneous to the message delivery 1550 process that advises the CDS 1200 that a message has been rendered; the behavior tracking 1563A-4 captures the message rendering duration, mobile device user 1401 interaction with the rendering message, and the event that ended the rendering; and then subsequently stores the captured information into the explicit data 1563A-8. The rendering duration is the time between the first triggering event and one of the following: the lock screen display times-out; the mobile device user 1401 deploys a logical or physical unlocking mechanism; or mobile device user 1401 deploys a logical or physical second triggering event. The mobile device user's 1401 interaction with the rendering message has numerous variables, as defined by the software developer 1220 author of the ad message. Each variable may have trackable elements. Subsequently, as each trackable element is engaged by the mobile device user 1401, the behavior tracking 1563A-4 captures and stores the captured trackable element into the explicit data 1563A-8. The event that ended the rendering is one of the following: the lock screen display times-out; the mobile device user 1401 deploys a logical or physical unlocking mechanism; or mobile device user 1401 deploys a logical or physical second triggering event. The behavior tracking 1563A-4 captures and stores the ending event into the explicit data 1563A-8. Additionally, if the first triggering event occurs and the event that ended the rendering was the lock screen display timing-out, the scheduling manager 1563A-1 keeps the current ad message at the top of the queue for re-rendering; the scheduling manager 1563A-1 maintains the current ad message at the top of the queue for re-rendering until the mobile device user 1401 deploys a logical or physical unlocking mechanism, mobile device user 1401 deploys a logical or physical second triggering event, or until the time block has expired and the scheduling manager 1563A-1 places a different ad message at the top of the queue. Consequently, each re-rendering causes the behavior tracking 1563A-4 to capture the message rendering duration, mobile device user 1401 interaction with the rendering message, and the event that ended the rendering; and then subsequently stores the captured information into the explicit data 1563A-8. Concurrently with each re-rendering, the message delivery 1550 processes a new confirmation that advises the CDS 1200 that a message has been rendered.

Immediately following a second triggering event, the rendering manager 1563A-2 transitions to the learn more 1563A-5 attributes of the ad message. The learn more 1563A-5 attributes have two components: the externally derived, Part B (1535-2, 1536-2, or 1537-2) of the ad message, the advertiser 1100 specific information that supplements the rendered message, and the internally derived framework to standardize and organize the mobile device user 1401 user experience for presentation and navigation of the Part B (1535-2, 1536-2, or 1537-2) component. The Part B (1535-2, 1536-2, or 1537-2) component is defined by the advertiser 1100 in the CDS 1200 and has the following attributes: 1) the companion page; 2) product, service or brand awareness illustrations: print media, video media, audio media, website, other; 3) product, service or brand interest illustrations: map or location, product, service or brand reviews, price comparison, survey or questionnaire, calling, emailing, texting, product, service or brand search, other; 4) product, service or brand desire illustrations: shopping list, wish list, gift list, shopping cart, other; 5) product, service or brand action illustrations: mobile ahead transactions, redeem coupon, in-store purchase, online purchase, review purchase history, other; 6) product, service or brand social illustrations: share, post, comment, update, visit, rank, influence, other; each aforementioned attribute provides trackable elements. The internal component of the learn more 1563A-5 contains a framework that standardizes the way each attribute is organized and how the mobile device user 1401 navigates, thus creating a consistent look and feel to the mobile device user 1401 for engaging each attribute across all product, service or brand categories. The learn more 1563A-5 draws resources from the DRC 1571 to support this illustration. Subsequently, the behavior tracking 1563A-4 captures each trackable element of each attribute and stores them in the explicit data 1563A-8.

In this embodiment, capturing, storing and transmitting the mobile device user's 1401 implicit behavior is illustrated. Implicit behavior is information derived indirectly from the mobile device user's 1401 exposure and interaction with advertisers 1100, which is not directly linked to a message. The behavior tracking 1563B-1 in the implicit manager 1563B captures the exposure and interaction of the mobile device user 1401 by monitoring transactions, activities, or data points that potentially could be linked to an advertiser's 1100 unique identifier or to a third-party application developer's (API) unique identifier (collectively referred to as implicit behavior).

All the implicit behavior captured by the behavior tracking 1563B-1 is stored and encrypted (1586) in the implicit data 1563B-8 in the behavior tracking folder 1563. Periodically, the behavior tracking 1563B-1 deploys the admin message 1510 processor of the MMP message processor 1503 to outbound transmit the implicit data 1563B-8 to CDS 1200 for further processing, via the MMP security agent 1502 and the MMP message agent 1501.

In this embodiment, the behavior tracking 1563B-1 captures implicit behavior of the mobile device user 1401; the mobile wallet interface 1563B-2 captures transactional information; the third-party audience measurement interface 1563B-3; and other context 1563B-4 captures other integrated services transitions. User profile cookie 1561 controls and captures transactions related to distributing the mobile device user's 1401 authorized personalized internet cookie.

The behavior tracking 1563B-1 capturing implicit behavior of the mobile device user 1401 is illustrated in this embodiment. The CML 1500 is manufactured into the mobile device operating system 1402, and with permission, has access to core functionality of the mobile device operating system 1402 to enable monitoring, and when programmed, captures designated transactions, activities, or data points performed by the mobile device user 1401; the behavior tracking 1563B-1 is the active element within the CML that performs this function. All captured implicit behavior is stored and encrypted (1586) in the implicit data 1563B-8 in the behavior tracking folder 1563; and if any unique identifiers for mobile device users 1401, advertisers 1100, messages, or third-party developers (API) are captured and can be associated with any of the implicit behavior, these items are also stored in the respective folders: 1563B-8-61, 1563B-8-40, 1563B-8-30, 1563B-8-70 with a linkage to the implicit data 1563B-8 stored.

The mobile wallet interface 1563B-2 capturing transactional information is illustrated in this embodiment. Mobile wallet is an alternative payment method; instead of paying with cash, check or credit cards, a mobile device user 1401 can use their mobile device 1400 to pay for a wide range of services and digital or hard goods; there are four primary models for mobile payments: premium SMS-based transactional payments, direct mobile billing, mobile web payments (WAP), contactless NFC (Near Field Communication). The mobile wallet interface 1563B-2 is manufactured into the mobile device operating system 1402 and with permission, has access to core functionality of the mobile device's 1400 mobile wallet to enable monitoring, and when programmed, captures designated transactional information performed by the mobile device user 1401 using his or her mobile wallet. All captured transactional information is stored and encrypted (1586) in the implicit data 1563B-8 in the behavior tracking folder 1563; and if any unique identifiers for mobile device users 1401, advertisers 1100, messages, or third-party developers (API) are captured and can be associated with any of the transactional information, these items are also stored in the respective folders: 1563B-8-61, 1563B-8-40, 1563B-8-30, 1563B-8-70 with a linkage to the implicit data 1563B-8 stored.

The third-party audience measurement interface 1563B-3 capturing third-party transactions and activities are illustrated in this embodiment. Third-party transactions and activities are viewing, listening, reading, browsing, social and other transactions and activities that are provided by third-party entities for the benefit of the mobile device user 1401 on his or her mobile device 1400; either executed by native mobile device 1400 applications or by non-native, remotely connected functionality. There are numerous embodiments of third-party transactions and activities that capture the exposure and interaction of the mobile device user 1401 by monitoring viewing, listening, reading, browsing, social and other transactions, activities, or data points that potentially could be linked to an advertiser's 1100 unique identifier or to a third-party application developer's (API) unique identifier. The third-party audience measurement interface 1563B-3 is manufactured into the mobile device operating system 1402 and with permission, has access to core functionality of the mobile device's 1400 viewing, listening, reading, browsing, social and other integrated services transactions to enable monitoring or receipt, and when programmed, captures or receives designated viewing, listening, reading, browsing, social and other integrated services transactions performed by the mobile device user 1401. All captured or received viewing, listening, reading, browsing, social and other integrated services transactions are stored and encrypted (1586) in the implicit data 1563B-8 in the behavior tracking folder 1563; and if any unique identifiers for mobile device users 1401, advertisers 1100, messages, or third-party developers (API) are captured or received and can be associated with any of the viewing, listening, reading, browsing, social and other integrated services transactions, these items are also stored in the respective folders: 1563B-8-61, 1563B-8-40, 1563B-8-30, 1563B-8-70 with a linkage to the implicit data 1563B-8 stored.

The other context 1563B-4 capturing other integrated services transactions is illustrated in this embodiment. There are numerous embodiments of other integrated services transactions that capture the exposure and interaction of the mobile device user 1401 by monitoring other transactions, activities, or data points that potentially could be linked to an advertiser's 1100 unique identifier or to a third-party application developer's (API) unique identifier. The other context 1563B-4 is manufactured into the mobile device operating system 1402 and with permission, has access to core functionality of the mobile device's 1400 other integrated services transactions to enable monitoring, and when programmed, captures designated other integrated services transactions performed by the mobile device user 1401. All captured other integrated services transactions are stored and encrypted (1586) in the implicit data 1563B-8 in the behavior tracking folder 1563; and if any unique identifiers for mobile device users 1401, advertisers 1100, messages, or third-party developers (API) are captured and can be associated with any of the other integrated services transactions, these items are also stored in the respective folders: 1563B-8-61, 1563B-8-40, 1563B-8-30, 1563B-8-70 with a linkage to the implicit data 1563B-8 stored.

The user profile cookie 1561 controlling and capturing transactions related to distribution of the mobile device user's 1401 authorized personalized internet cookie is illustrated in this embodiment. The mobile device user 1401 defines and administers his or her profile information in the CDS 1200, and with permission, authorizes the distribution of his or her personalized internet cookie representing his or her profile information (see paragraph [0128]). The user profile cookie 1561 is manufactured into the mobile device operating system 1402, and with permission, has access to core functionality of the mobile device's 1400 web browser to distribute the mobile device user's 1401 authorized personalized internet cookie and to enable monitoring, and when programmed, captures designated transactions performed by the mobile device user 1401 using his or her web browser. All captured personalized internet cookie distribution and subsequent captured transactions are stored and encrypted (1585) in the implicit data 1563B-8 in the behavior tracking folder 1563; and if any unique identifiers for mobile device users 1401, advertisers 1100, messages, or third-party developers (API) are captured and can be associated with any of the personalized internet cookie distribution and subsequent transactions, these items are also stored in the respective folders: 1563B-8-61, 1563B-8-40, 1563B-8-30, 1563B-8-70 with a linkage to the implicit data 1563B-8 stored.

Those skilled in the art will appreciate that the above-described processes are readily enabled using any of a wide variety of available and/or readily configured platforms, including partially or wholly programmable platforms as are known in the art or dedicated purpose platforms as may be desired for some applications. In an additional alternative embodiment, the functionality or logic described in the figures may be embodied in the form of code that may be executed in a separate processor circuit. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A display control mechanism for improving functionality of a handheld mobile device including an operating system (OS), the display control mechanism comprising:
a content delivery system (CDS) configured to create an advertising (ad) message, the ad message being represented by templates formatted into a plurality of portions;
wherein (i) a first of the template portions includes instructions directing how to render the ad message to interact with the mobile device based upon capabilities of the device, (ii) a second of the template portions includes instructions directing what to render as content of the ad message based upon the device capabilities; and (iii) a third of the template portions includes data for use in rendering the ad message; and
wherein the CDS is configured to compare the first template portion instructions to registered capabilities of other mobile devices to determine a percentage of the other mobile devices capable of receiving the ad message;
a formatted data package for (i) transmitting the first, second, and third template portions between the CDS and the mobile device in accordance with existing service provider protocols and (ii) optimizing communication therebetween; and
a content message layer (CML) for manipulating the OS and the device capabilities, the CML including one or more application programming interfaces (APIs) configured to receive, store, and render messages sent by CDS,
wherein a scheduling API is configured to queue the plurality of template portions for rendering after a first triggering wake-up event responsive to the manipulating of the OS; and
wherein a rendering API executes the first and second template portion instructions.

2. The display control mechanism of claim 1, wherein a physics engine API is configured to activates functionality of the device capabilities in accordance with the third template portion data when the first and second template instructions are rendered.

3. The display control mechanism of claim 1, wherein the operating system is a digital operating system with machine executable code configured for controlling a transmitter, a receiver, a memory, a processor, a display, a physics engine, and a plurality of other handheld mobile devices.

4. The display control mechanism of claim 1, wherein the templates are addressable.

5. The display control mechanism of claim 4, further comprising dedicated memory segments/folders configured for storing addressable message templates.

6. The display control mechanism of claim 1, further comprising a display screen responsive to OS instructions to switch between alternative display control mechanism modes including a sleep mode, an awake mode, and an active mode.

7. The display control mechanism of claim 6, further comprising a trigger device configured for producing (i) the first triggering wake-up event, (ii) an unlocking triggering event, and a time-out trigger signal.

8. The display control mechanism of claim 7, further comprising a switching device responsive to the trigger device and including the OS, the switching device configured to permitting target messages to be viewed on the display screen (i) at a time selected by a user and (ii) if the display is in the awake mode.

9. The display control mechanism of claim 8, wherein the switching device includes an explicit manager configured for performing the rendering and capturing user engagement data.

10. A method for improving functionality of a handheld mobile device including an operating system (OS), the method comprising:
creating, via a content delivery system (CDS), an advertising (ad) message, the ad message being represented by templates formatted into a plurality of portions;
wherein (i) a first of the template portions includes instructions directing how to render the ad message to interact with the mobile device based upon capabilities of the device, (ii) a second of the template portions includes instructions directing what to render as content of the ad message based upon the device capabilities; and (iii) a third of the template portions includes data for use in rendering the ad message; and
wherein the CDS is configured to compare the first template portion instructions to registered capabilities of other mobile devices to determine a percentage of the other mobile devices capable of receiving the ad message;
formatting a data package for (i) transmitting the first, second, and third template portions between the CDS and the mobile device in accordance with existing service provider protocols and (ii) optimizing communication therebetween; and
manipulating, via a content message layer (CML), the OS and the device capabilities, the CML including one or more application programming interfaces (APIs) configured to receive, store, and render messages sent by CDS,
wherein a scheduling API is configured to queue the plurality of template portions for rendering after a first triggering wake-up event responsive to the manipulating of the OS; and
wherein a rendering API executes the first and second template portion instructions.

11. The method of claim 10, wherein a physics engine API is configured to activates functionality of the device capabilities in accordance with the third template portion data when the first and second template instructions are rendered.

12. The method of claim 10, wherein the operating system is a digital operating system with machine executable code configured for controlling a transmitter, a receiver, a memory, a processor, a display, a physics engine, and a plurality of other handheld mobile devices.

13. The method of claim 10, wherein the templates are addressable.

14. The method of claim 3, further comprising dedicated memory segments/folders configured for storing addressable message templates.

15. The method of claim 10, further comprising switching, via a display screen, between alternative display control mechanism modes including a sleep mode, an awake mode, and an active mode.

16. The method of claim 15, further comprising a trigger device configured for producing (i) the first triggering wake-up event, (ii) an unlocking triggering event, and a time-out trigger signal.

17. The method of claim 6, further comprising viewing, via a switching device responsive to the trigger device and including the OS, messages on the display screen (i) at a time selected by a user and (ii) if the display is in the awake mode.

18. The method of claim 17, further comprising performing the rendering, via an explicit manager, wherein the explicit manager is configured for capturing user engagement data.

19. A computer readable medium having stored thereon, computer-executable instructions that, when executed by a computer processor, cause the computer processor to perform a method comprising:
creating, via a content delivery system (CDS), an advertising (ad) message, the ad message being represented by templates formatted into a plurality of portions;
wherein (i) a first of the template portions includes instructions directing how to render the ad message to interact with the mobile device based upon capabilities of the device, (ii) a second of the template portions includes instructions directing what to render as content of the ad message based upon the device capabilities; and (iii) a third of the template portions includes data for use in rendering the ad message; and
wherein the CDS is configured to compare the first template portion instructions to registered capabilities of other mobile devices to determine a percentage of the other mobile devices capable of receiving the ad message;
formatting a data package for (i) transmitting the first, second, and third template portions between the CDS and the mobile device in accordance with existing service provider protocols and (ii) optimizing communication therebetween; and
manipulating, via a content message layer (CML), the OS and the device capabilities, the CML including one or more application programming interfaces (APIs) configured to receive, store, and render messages sent by CDS,
wherein a scheduling API is configured to queue the plurality of template portions for rendering after a first triggering wake-up event responsive to the manipulating of the OS; and
wherein a rendering API executes the first and second template portion instructions.

20. The computer readable medium of claim 19, wherein a physics engine API is configured to activates functionality of the device capabilities in accordance with the third template portion data when the first and second template instructions are rendered.

21. The computer readable medium of claim 19, wherein the operating system is a digital operating system with machine executable code configured for controlling a transmitter, a receiver, a memory, a processor, a display, a physics engine, and a plurality of other handheld mobile devices.

22. The computer readable medium of claim 19, wherein the templates are addressable.

23. The computer readable medium of claim 22, further comprising dedicated memory segments/folders configured for storing addressable message templates.

24. The computer readable medium of claim 19, further comprising switching, via a display screen, between alternative display control mechanism modes including a sleep mode, an awake mode, and an active mode.

25. The computer readable medium of claim 24, further comprising a trigger device configured for producing (i) the first triggering wake-up event, (ii) an unlocking triggering event, and a time-out trigger signal.

26. The computer readable medium of claim 25, further comprising viewing, via a switching device responsive to the trigger device and including the OS, messages on the display screen (i) at a time selected by a user and (ii) if the display is in the awake mode.

27. The computer readable medium of claim 26, further comprising performing the rendering, via an explicit manager, wherein the explicit manager is configured for capturing user engagement data.

28. A display control mechanism for improving functionality of a handheld mobile device including an operating system (OS), the display control mechanism comprising:
a content delivery system (CDS) configured to create an advertising (ad) message that takes advantage of the mobile device's capabilities for rendering, interacting, and scheduling purposes, the ad message being represented by templates formatted into a plurality of portions;
wherein (i) a first of the template portions includes instructions on how to render and enable the device user to interact with the ad message utilizing the mobile device's capabilities, (ii) a second of the template portions includes instructions on what, when, and where to render an ad message utilizing the mobile device's capabilities; and (iii) a third of the template portions include mobile device digital elements pre-stored therein, a digital resource center (DRC) including tools, objects, rich media, data, audio files, physics engine elements, and other digitized elements for use in ad message rendering and interaction; and
wherein the CDS is configured to compare components of the first template portion against device capabilities of registered mobile devices to determine a percentage of devices capable of fully rendering and interacting the ad message;
a formatted data package for (i) transmitting the first, second, and third template portions to and from mobile devices in accordance with existing communication service provider's network and protocols and (ii) to optimize communication relationship between the CDS and a content message layer (CML); and
a content message layer (CML) for interfacing and manipulating the OS, device storage, and the device capabilities, the CML including one or more application programming interfaces (APIs) configured to receive, store, process, schedule, render, and interact ad messages sent by CDS,
wherein based on delivery elements in the second template portion and device capabilities, a scheduling API is configured to queue the plurality of template portions and to wait for a first triggering wake-up event responsive to the manipulating of the OS;
wherein after a first triggering wake-up event, a rendering API executes the instructions of the first and second template portions, the functionality of mobile device capabilities, and the pre-stored elements of the DRC; and
wherein a physics engine API is configured to activate functionality of the device capabilities in accordance with the rendering and interaction instructions of the first, second and third template portions.
